(19) United States
(12) Patent Application Publication
(10) Pub. No.: US 2008/0022342 A1
(43) Pub. Date: Jan. 24, 2008

(54) Program Creation Support System

(75) Inventors: Yasuaki Inatomi, Kanagawa (JP); Mitsuhiro Kageyama, Tokyo (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/575,675

(22) PCT Filed: Sep. 27, 2005
(86) PCT No.: PCT/JP05/17708

§ 371 Date: Mar. 21, 2007

(30) Foreign Application Priority Data
Sep. 27, 2004 (JP) 2004-279777
Sep. 12, 2005 (JP) 2005-264109

(51) Int. Cl. H04N 7/173; H04N 7/16

(52) U.S. Cl. 725/114; 725/134; 725/142; 725/138; 348/722

(57) ABSTRACT

The present invention has an object capable of improving a work efficiency of planning a program.

A program planning supporting system of the present invention corresponds to a program planning supporting system equipped with a structure work terminal 100 and a response work terminal 200, in which the structure work terminal 100 comprises an instruction data inputting unit 11 for inputting instruction data required for an editing instruction, an instruction data transmitting unit 12 for transmitting the instruction data to the response work terminal 200, a response data receiving unit 21 for receiving response data transmitted by the response work terminal 200, and a response data display unit 22 for displaying the received response data in relation to the program structural table, and in which the response work terminal 200 comprises an instruction data receiving unit 51 for receiving the instruction data transmitted by the structure work terminal 100, an instruction data display unit 52 for displaying the received instruction data in relation to the program structural table, a response data inputting unit 61 for inputting response data which is required in the edit work, and a response data transmitting unit 62 for transmitting the response data to the structure work terminal 100.

### TECHNICAL FIELD

The present invention is related to a program planning supporting system used in a broadcasting station, and the like.

### BACKGROUND ART

Very recently, since television broadcasting systems are digitalized and television broadcasting modes are modified in various manners, work loads of planning programs given to broadcasting stations are increased. To avoid the difficulty, planning works of programs are tried to be entirely, or partially carried out in an automatic manner in order to shorten time required for the planning works, and reduce man power. For instance, news-purpose announce text managing apparatus and the like have been proposed (refer to, for example, patent document 1). That is, the news-purpose announce text managing apparatus monitors conditions of planning announce texts used in news programs so as to shorten time durations from orders of these announce texts up to completions thereof.

On the other hand, while contents which are managed based upon program structural tables of news programs have been restricted to such objective information as news items and time frames, contents of works which are carried out based upon the program structural tables are also restricted to such specific works as planning of texts. As a consequence, instructions such as editing works can be automatically and easily issued based upon these program structural tables.

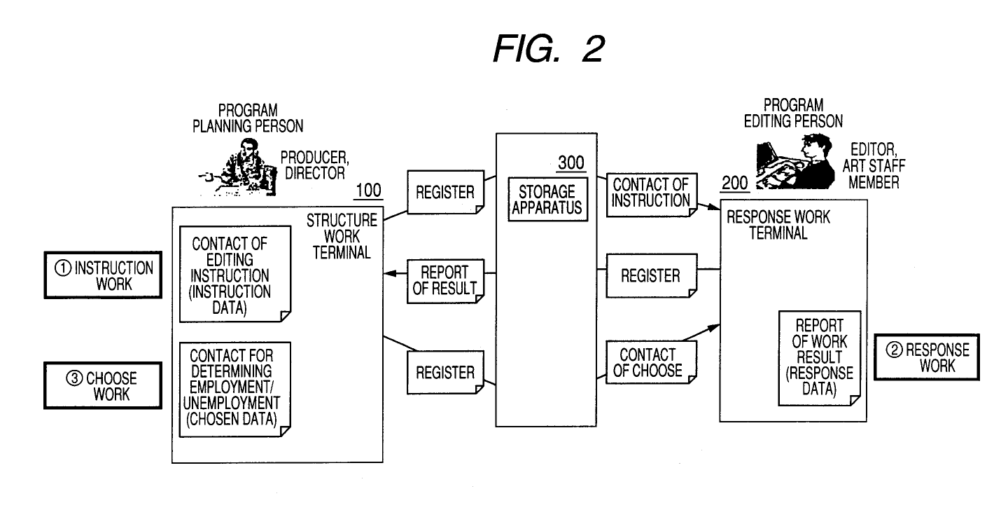

Patent document 1: Japanese Patent No. 2882348 (pages 3 to 5, FIG. 2)

### DISCLOSURE OF THE INVENTION

### Problems that the Invention is to Solve

However, the above-explained automatic work instructing operations (editing works) based upon the program structural tables cannot be applied to other general-purpose programs (for example, drama and documentary programs). This is because contents of editing work instructions as to general-purpose programs based upon the program structural tables are made up in various ways. For instance, in the case of drama, even in pictures of the same scene, editing instructions given to picture editing persons may have very small different nuance from each other, depending upon drama planning persons. Work instructions such as editing works contain subjective elements of work instructing persons, which is a different nature from program structural tables corresponding to objective information. In the related systems, these subjective information and objective information are not managed by being clearly discriminated from each other, but effective editing works cannot be realized by considering the respective natures thereof.

Moreover, in related picture databases, information which is related to picture materials is constituted only by such objective information as photographing day/time, and photographing objects. As a result, when the objective information is employed as a retrieve key in a retrieving operation, an object picture cannot be specified. Therefore, it is practically difficult that a desirable picture material which is used in editing works is properly and quickly retrieved from a large amount of picture libraries.

The present invention has been made to solve the above-explained problem, and has an object to provide a program planning supporting system capable of forming a program structural table onto which a planning intention of a program planning person is properly reflected, and capable of improving a work efficiency of planning programs based upon the formed program planning table.

Also, an object of the present invention is to provide such a program planning supporting system. That is, in a stage for forming a program structural table, since such a historical information that picture materials are related to subjective information indicative of features of these pictures is formed to be held, the program planning supporting system is capable of retrieving picture materials based upon the subjective information, and thus, is capable of properly and quickly retrieving a desirable picture material.

### Means for Solving the Problems

A program planning supporting system, according to the present invention, is featured by such a program planning supporting system comprising: a structure work terminal for performing a structure work of a program structural table which is required to plan a program; and a response work terminal for performing an edit work of the program structural table in response to an editing instruction required in the structure work of the program structural table; in which the structure work terminal comprises: an instruction data inputting unit for inputting editing instruction data required for the editing instruction; an instruction data transmitting unit for transmitting the editing instruction data to the response work terminal; a response data receiving unit for receiving response data transmitted by the response work terminal; and a response data display unit for displaying the received response data in relation to the program structural table; and in which the response work terminal comprises: an instruction data receiving unit for receiving the editing instruction data transmitted by the structure work terminal; an instruction data display unit for displaying the received editing instruction data in relation to the program structural table; a response data inputting unit for inputting response data which is required in the edit work; and a response data transmitting unit for transmitting the response data to the structure work terminal.

In accordance with the above-explained arrangement, every time either the instruction data or the response data is transmitted from either the structure work terminal or the response work terminal, since either the instruction data or the response data is reflected onto the program structural table, the program can be planned based upon the program structural table onto which the intention of the program planning person is properly reflected, and thus, the work efficiency of the program planning operation can be improved.

Also, the program planning supporting system of the present invention is featured by that the structure work terminal comprises: a chosen data inputting unit for inputting chosen data which is required to choose the edit work performed by the response work terminal; and a chosen data transmitting unit for transmitting the inputted chosen data to the response work terminal; and in which the response work terminal comprises: a chosen data receiving unit for receiving chosen data which is transmitted by the structure work terminal; and a chosen data display unit for displaying the received chosen data in relation to the program structural table.

In accordance with the above-described arrangement, a condition for indicating as to whether chosen data is employed or not employed with respect to the edit work executed in the response work terminal is transferred from the program planning person to the program editing person, and the program editing person can confirm the condition based upon the program structural table. As a result, the work efficiency of planning the program can be improved.

Also, the program planning supporting system of the present invention is featured by comprising: a storage apparatus for storing thereinto the editing instruction data, the response data, and the chosen data; and a material historical data managing unit including: subjective information acquiring means for acquiring subjective information indicative of features of picture materials which are related to the editing instruction data, the response data, and the chosen data from the instruction data, the response data, and the chosen data stored in the storage apparatus, respectively; material historical data producing means for producing material historical data which causes the acquired subjective information to be related to the picture material; and material historical data registering means for registering the produced material historical data into the storage apparatus.

In accordance with the above-explained arrangement, such a material historical data is produced in which the picture material is related to the subjective information indicative of the feature of this picture material, and then, the produced material historical data is stored in the storage apparatus. As a result, since the picture material can be retrieved based upon the subjective information, the desirable picture material can be properly and quickly retrieved.

Also, the program planning supporting system of the present invention is featured by that the material historical data managing unit includes a data judging unit for judging that the chosen data is stored in the storage apparatus; and the material historical data producing means produces the material historical data at a time when the chosen data is stored in the storage apparatus.

In accordance with the above-described arrangement, since the material historical data containing the chosen result after the choosing operation is accomplished is produced, the picture material can be retrieved based upon the subjective information by including the chosen results (OK, NG, unemployment reason), and thus, the desirable material can be properly retrieved.

The subjective information contained in the instruction owns poor reliability until the choosing operation is carried out. For example, even when a word of “fine” is written in an instruction, in the case that a chosen result becomes “NG”, there are some possibilities of a material which does not actually satisfy a condition of “fine.” As a consequence, if material historical data is produced (namely, retrieving operation can be carried out) under no choice, then there is a risk that a retrieved result may become incorrect. However, while the material historical data contains the chosen result after the choosing operation has been accomplished, this material historical data is produced, so that such a material of “fine” can be correctly retrieved by entering both the word of “fine” and “OK” as the retrieve keyword.

Also, the program planning supporting system of the present invention is featured by that the material historical data producing means includes a keyword antonym converting unit for producing an antonym of a word which is contained in the instruction content of the instruction data, and relates the antonym to be as the subjective information of an unemployed picture material.

In accordance with the above-explained arrangement, since the material historical data is produced by employing the antonym of the instruction word, the subjective information capable of properly indicating the feature of the unemployed picture material can be related to this picture. As a consequence, the picture material can be retrieved based upon the subjective information, so that the desirable picture material can be properly and quickly retrieved.

Also, the program planning supporting system of the present invention is featured by that the material historical data producing means includes an improper keyword deleting unit for deleting a word which corresponds to an antonym of a word contained in an unemployment reason of the chosen data from words contained in an instruction content of the instruction data, and relates both the word contained in the instruction content after deletion and the word contained in the unemployed reason to be as the subjective information of the unemployed picture material.

In accordance with the above-described arrangement, since the material historical data is produced by deleting the improper instruction word which corresponds to the antonym of the unemployment reason, only the subjective information capable of properly indicating the feature of the unemployed picture material can be related to this picture. As a consequence, the picture material can be retrieved based upon the subjective information, so that the desirable picture material can be properly and quickly retrieved.

Furthermore, a program structural table, according to the present invention, is featured by such a program structural table required for planning a program, comprising: an editing instruction region for displaying a content of an editing instruction which is required in a structure work of the program structural table in accordance with a program progress; and an editing work region for displaying a content of an edit work which is executed with respect to the editing instruction in correspondence with the editing instruction.

In accordance with the above-explained arrangement, since the contents of the editing instructions are caused to be related to the contents of the editing works in the program structural table, the program planning work can be carried out based upon the program structural table to which the intention of the program planning person is correctly reflected. As a result, the work efficiency of planning the programs can be improved.

### ADVANTAGE OF THE INVENTION

In accordance with the present invention, since the subjective information such as the editing instructions, and the objective information such as the program structures are related to each other, and further, are managed in the separate manner, such a program structural table can be formed to which the planning intention of the program planning person is correctly reflected, and thus, the work efficiency based upon the program structural table can be improved.

Also, such a material historical data is produced in which the picture material is related to the subjective information indicative of the feature of this picture material, and then, the produced material historical data is stored in the storage apparatus. As a result, since the picture material can be retrieved based upon the subjective information, the desirable picture material can be properly and quickly retrieved.

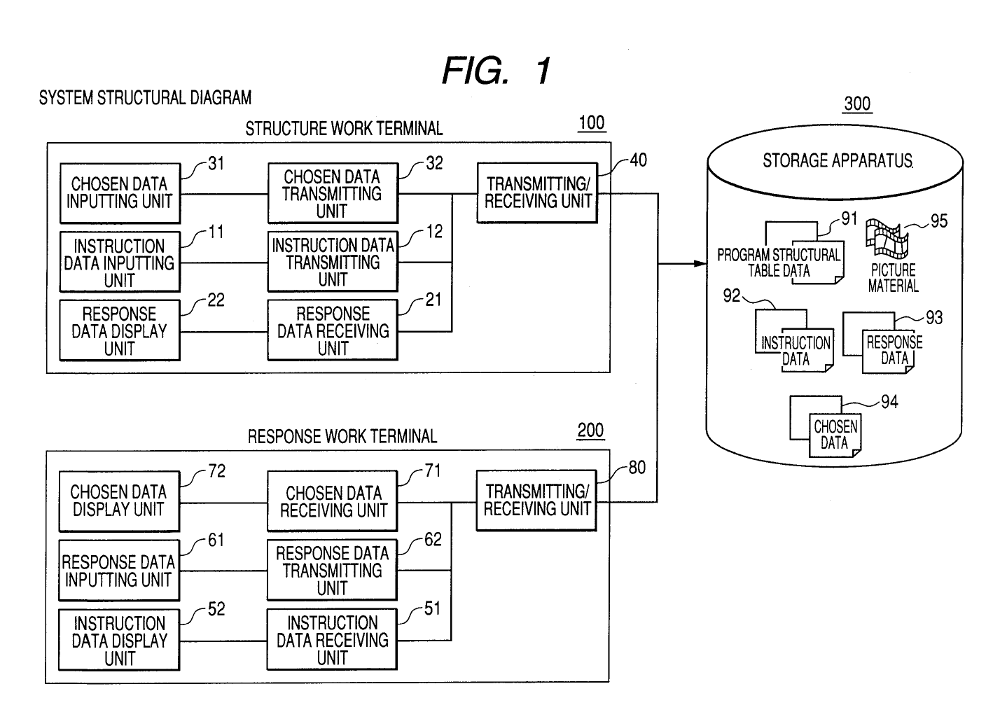

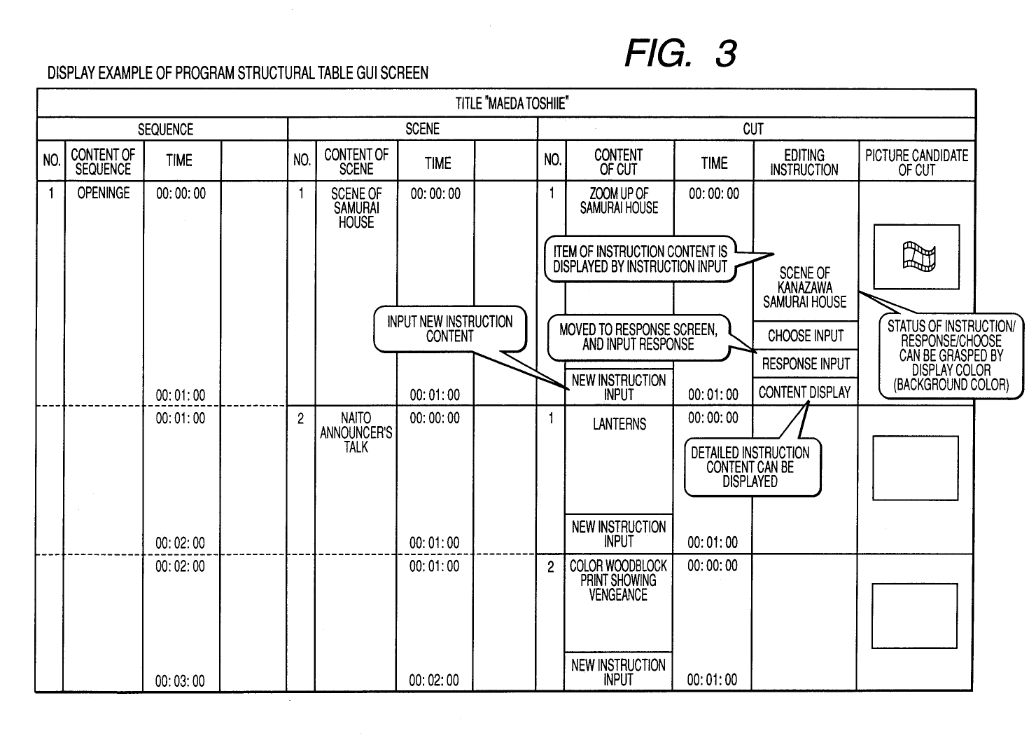

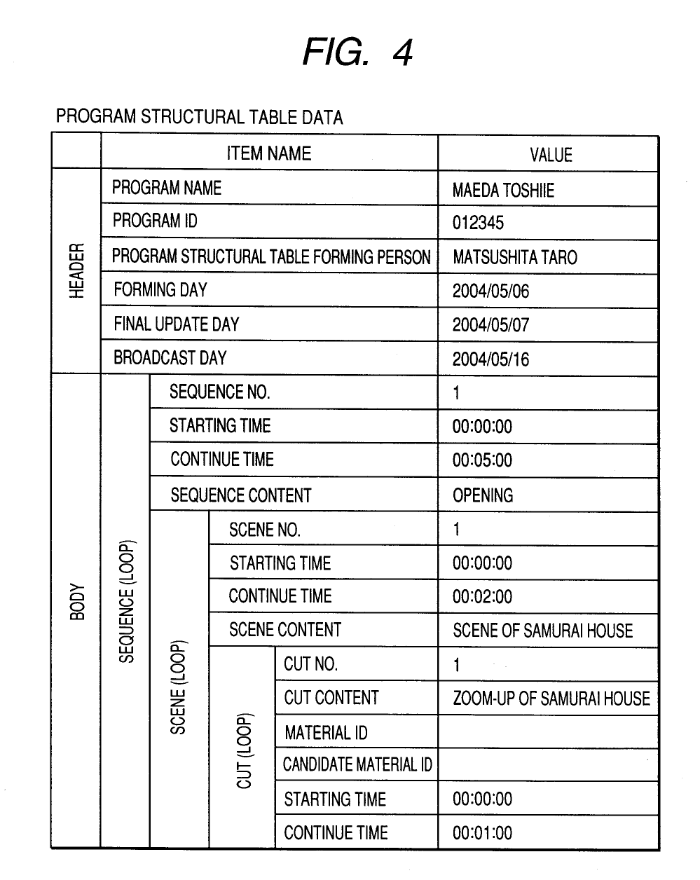

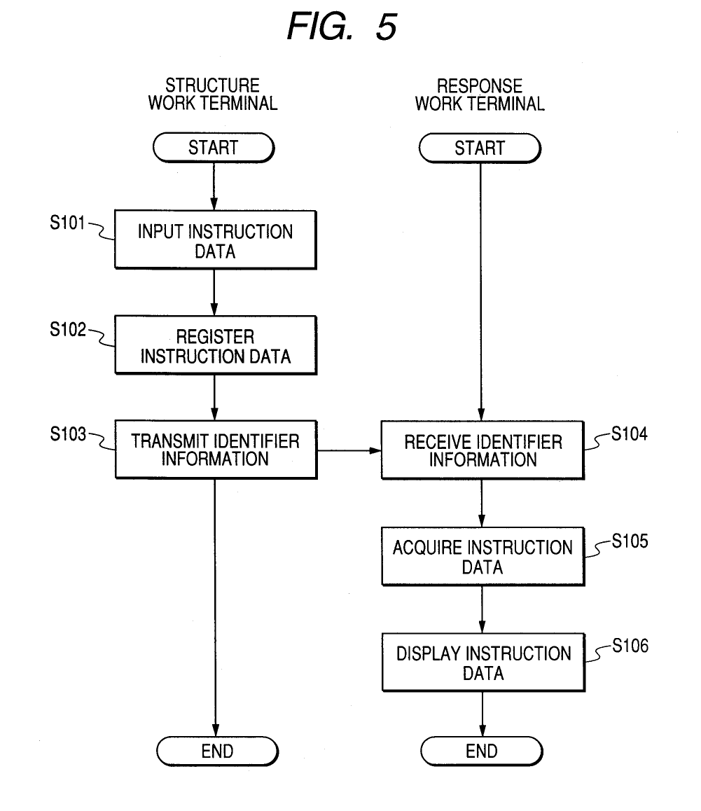

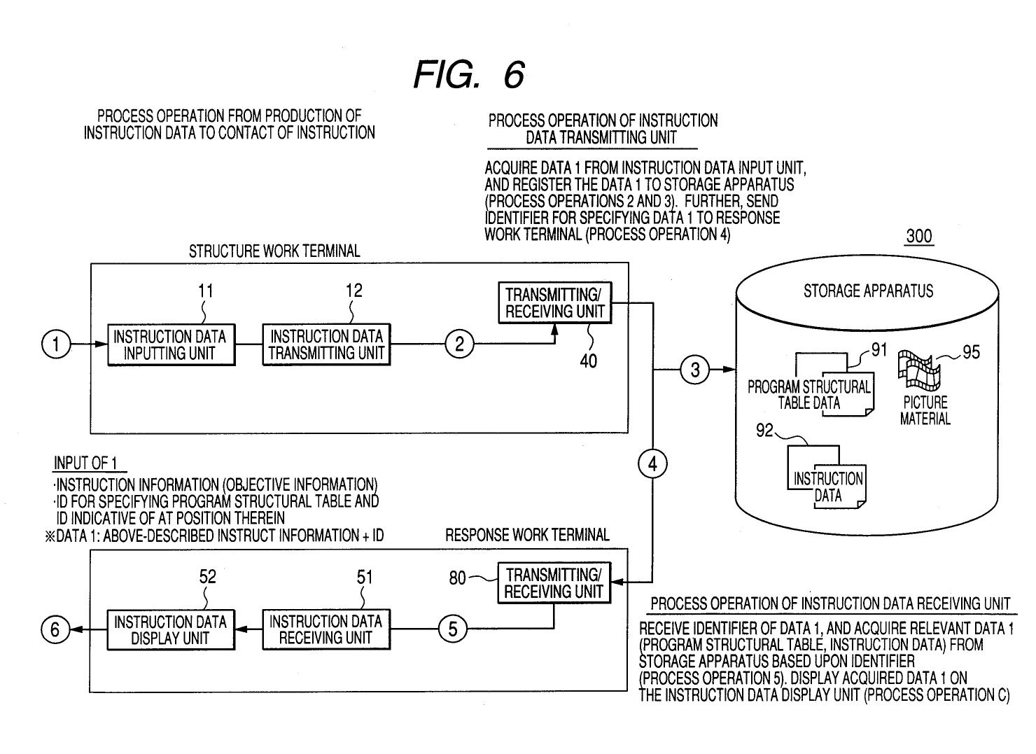

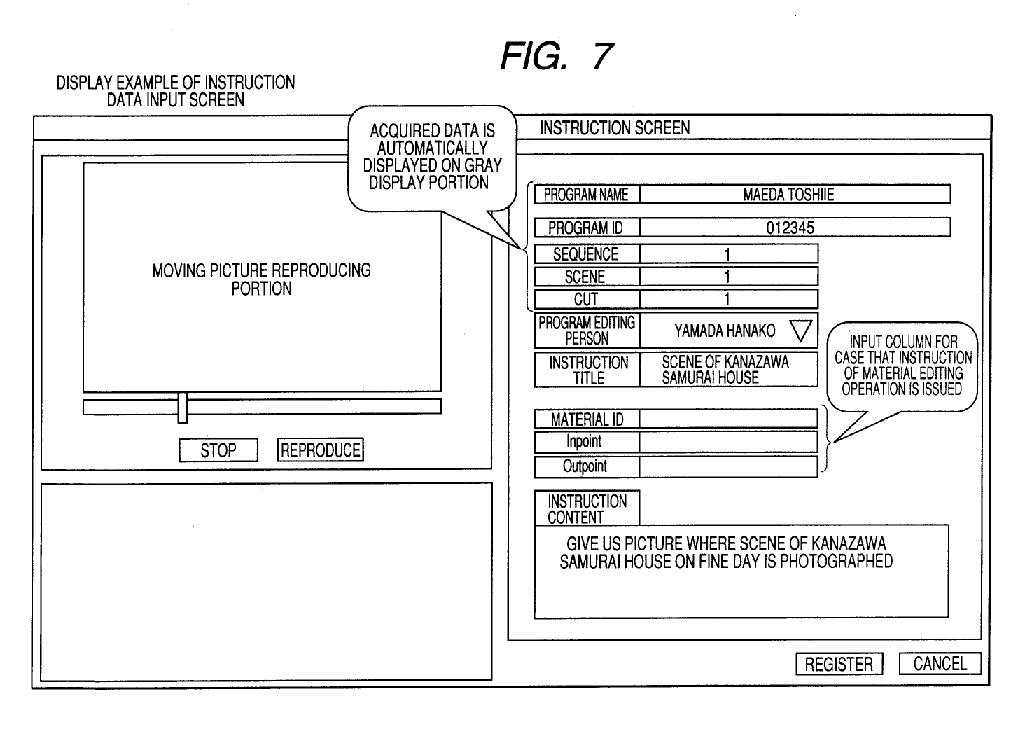

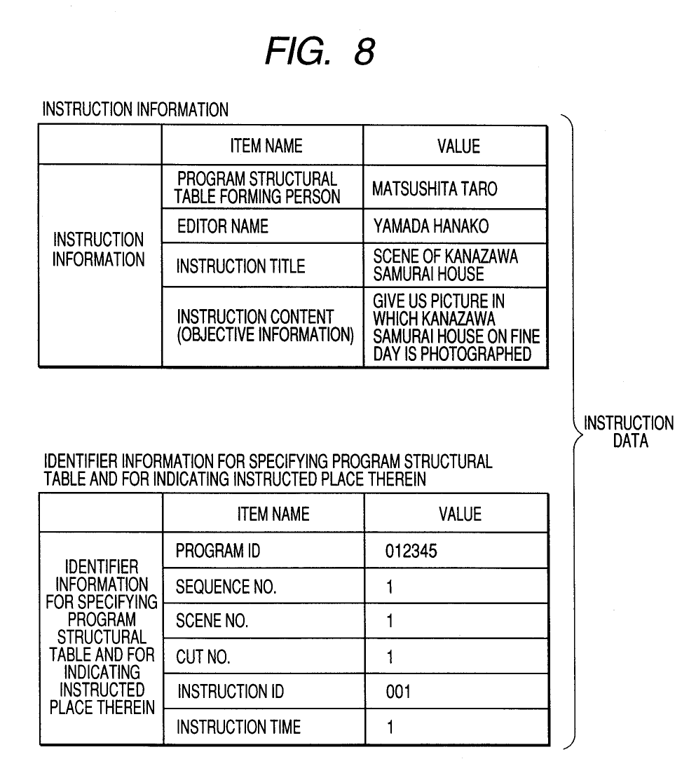

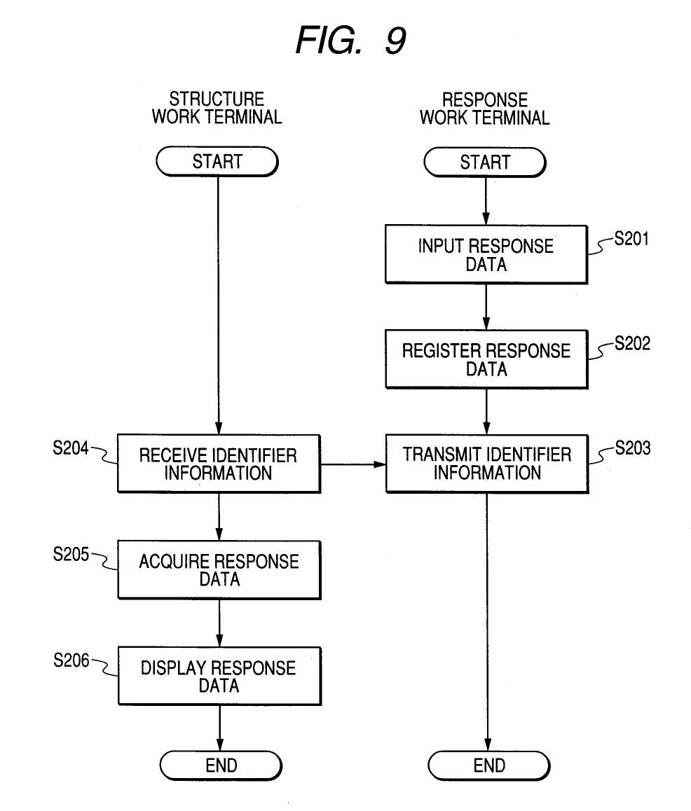

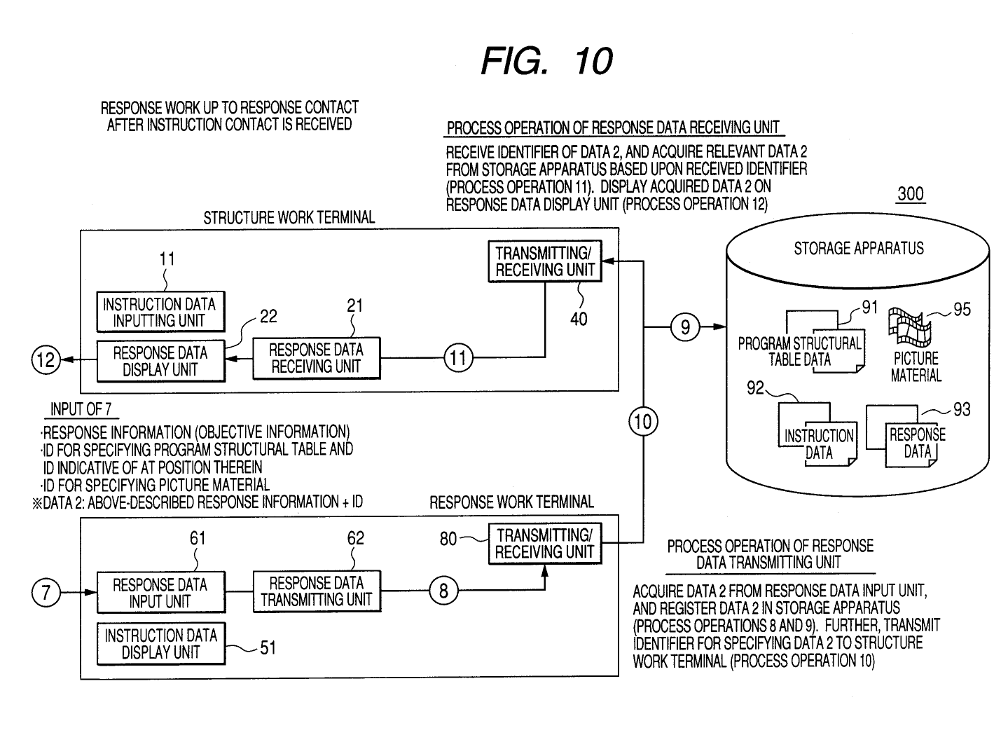

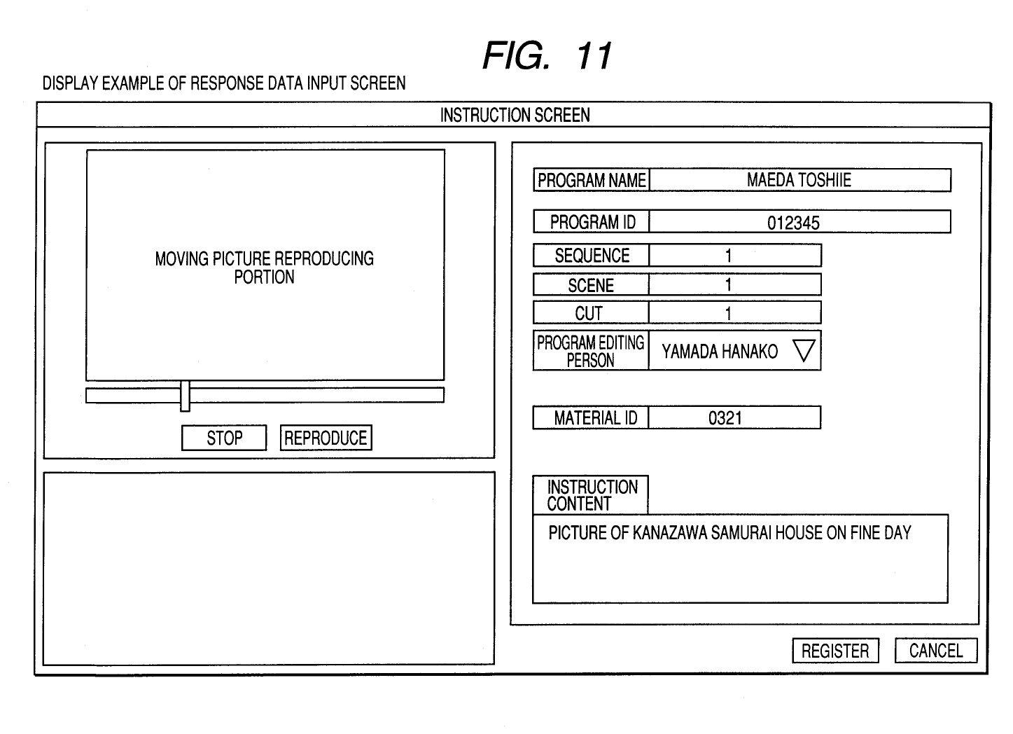

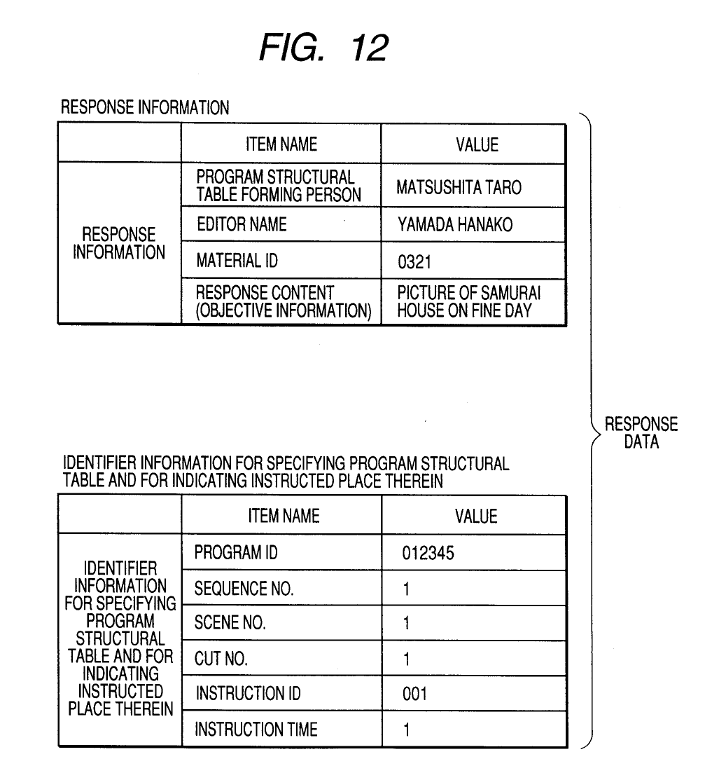

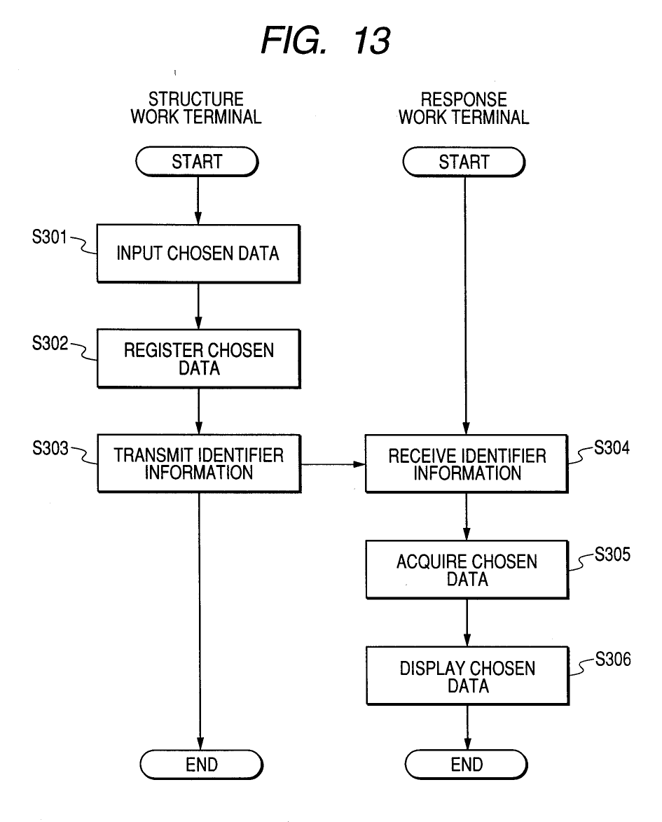

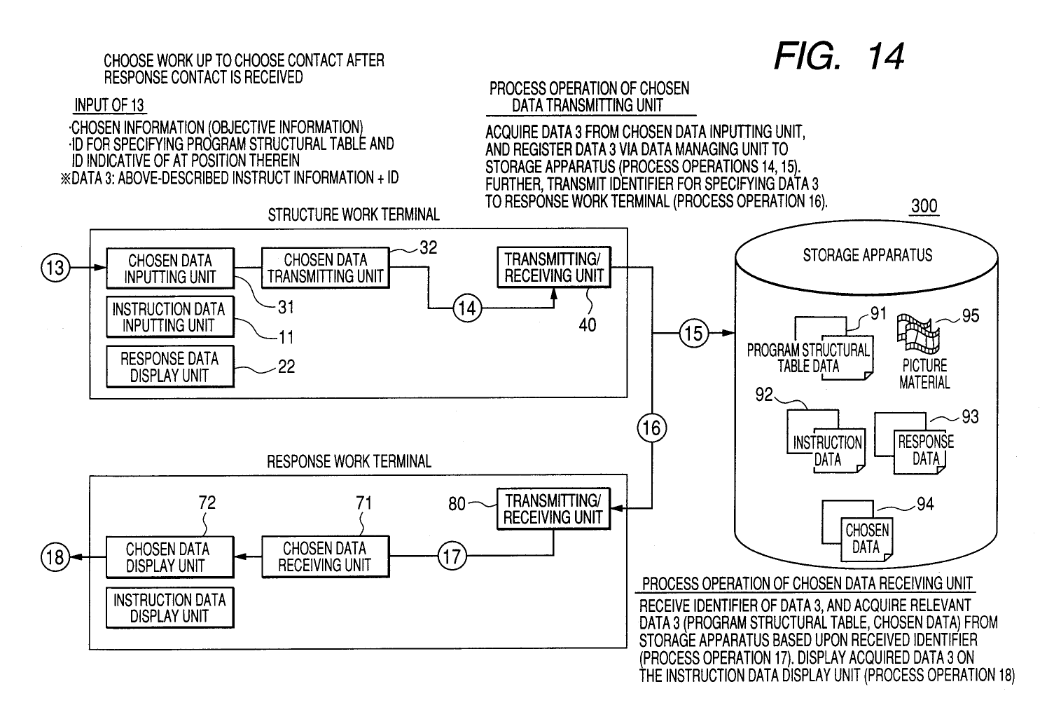

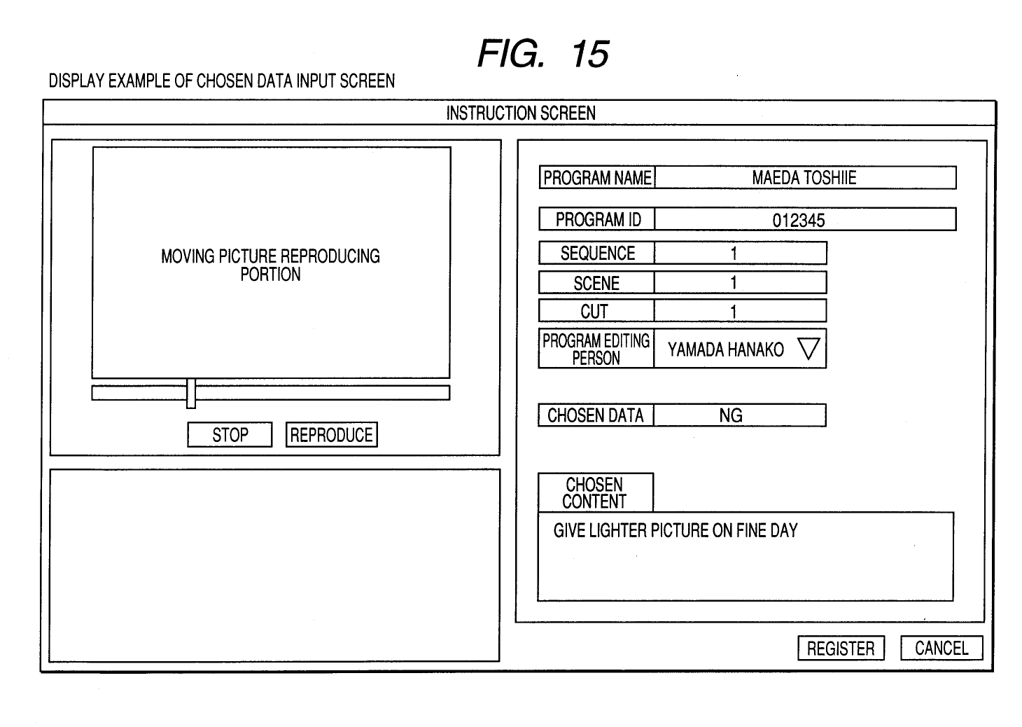

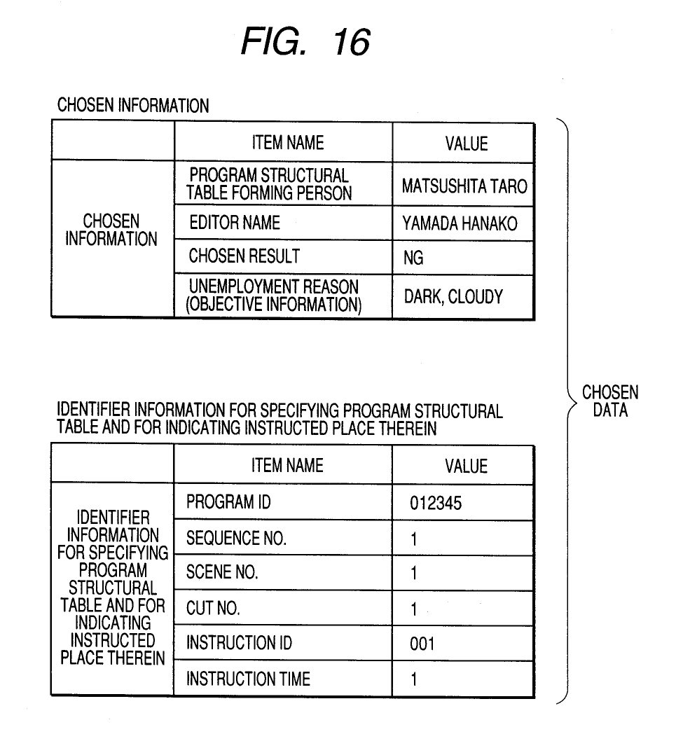

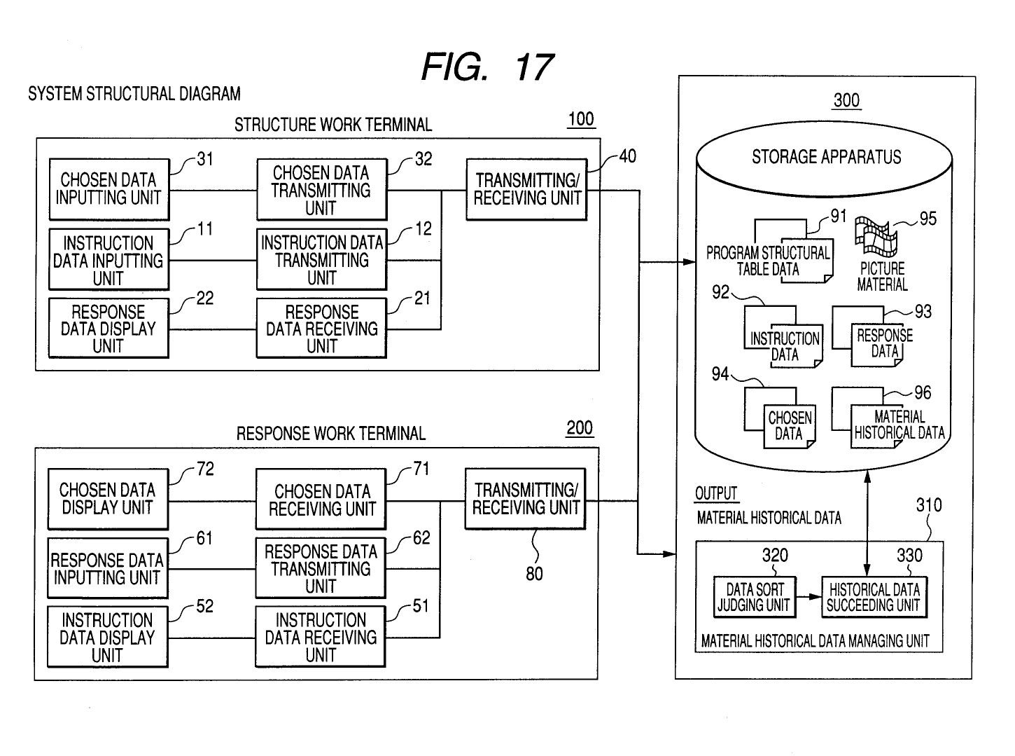

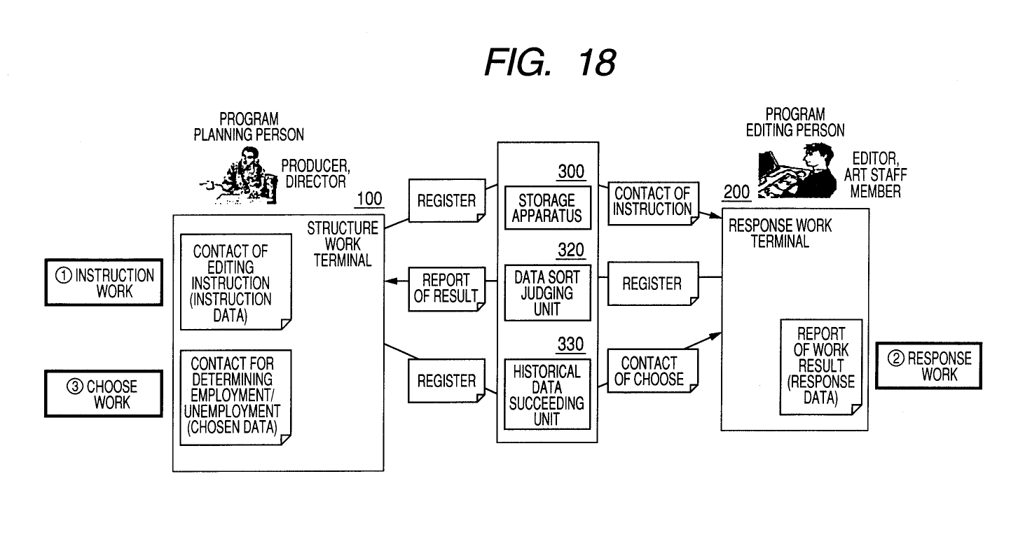

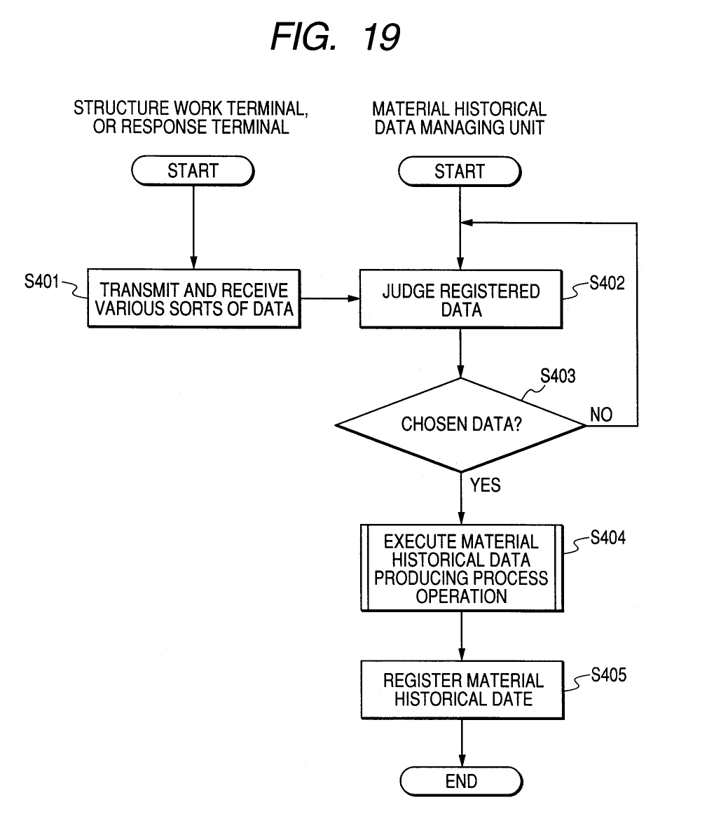

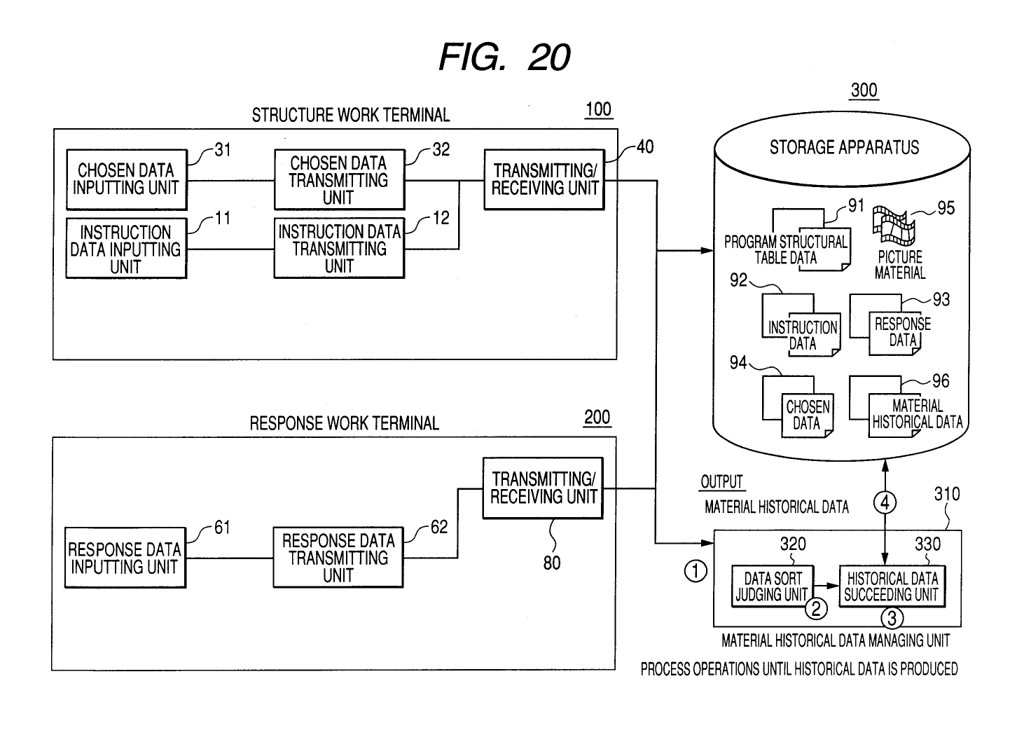

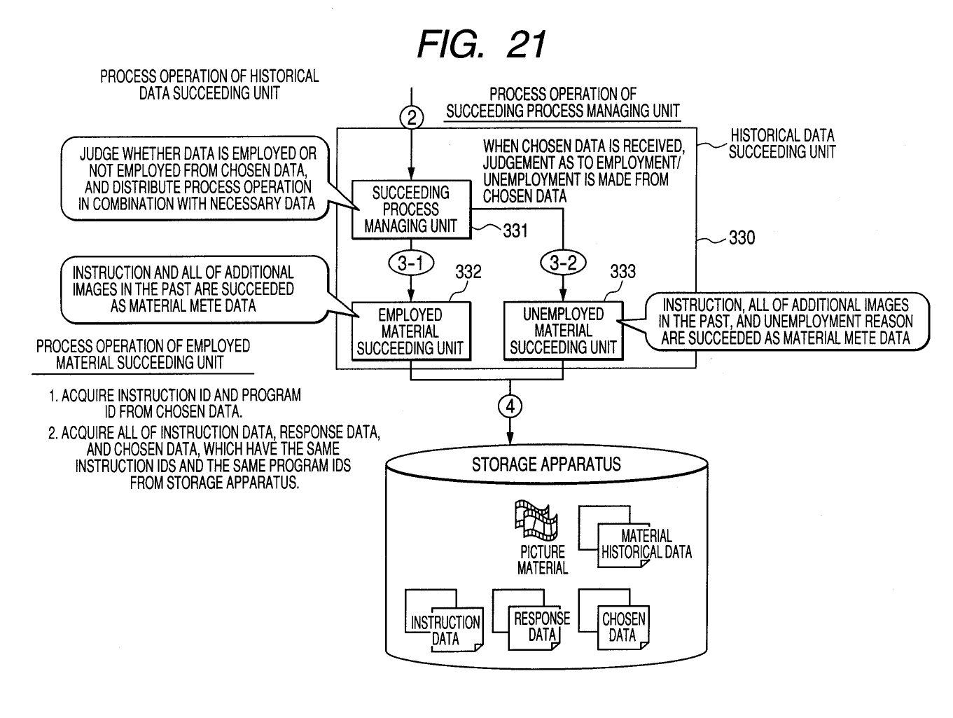

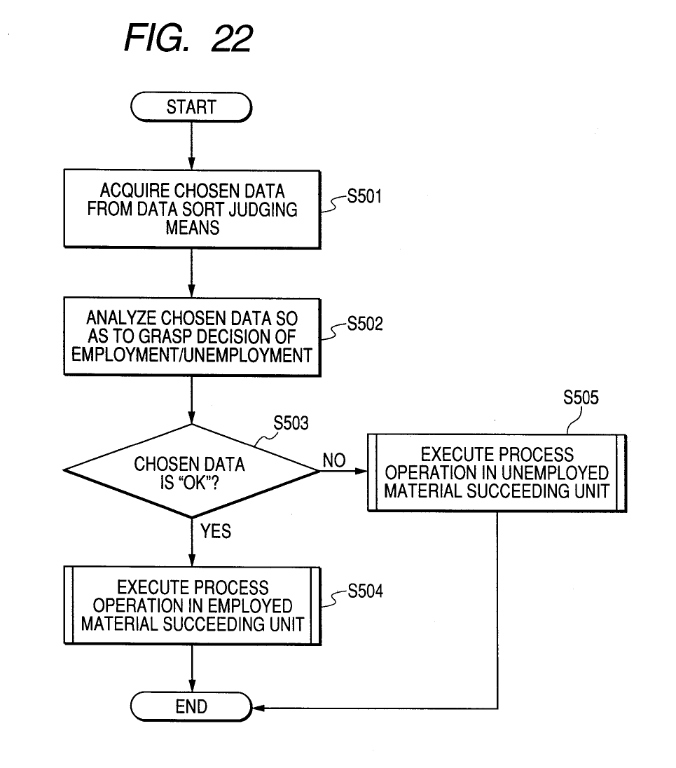

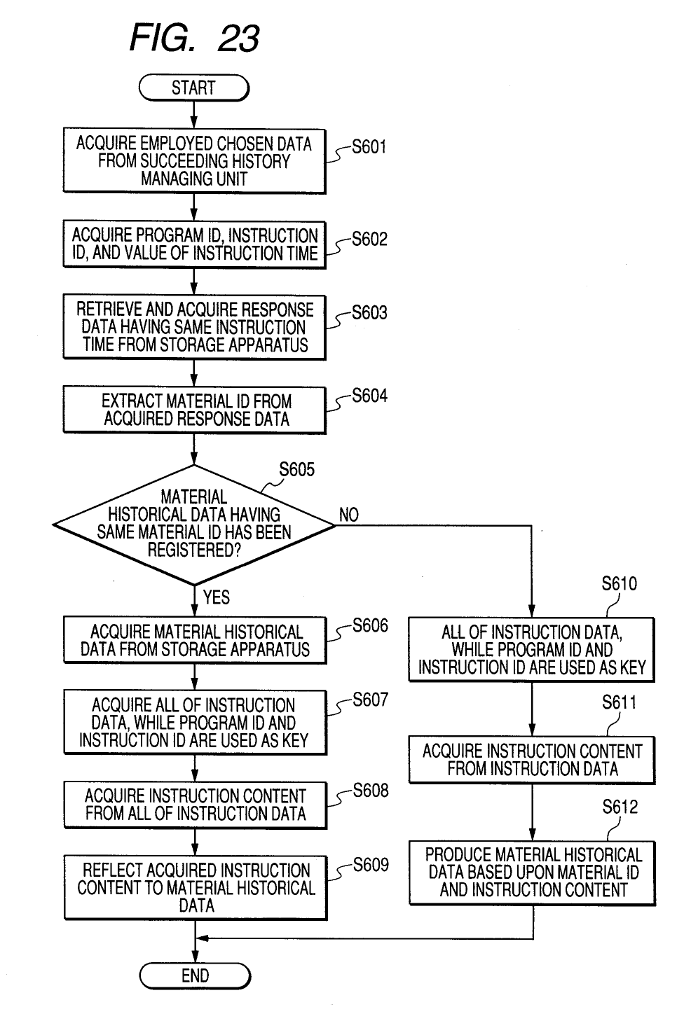

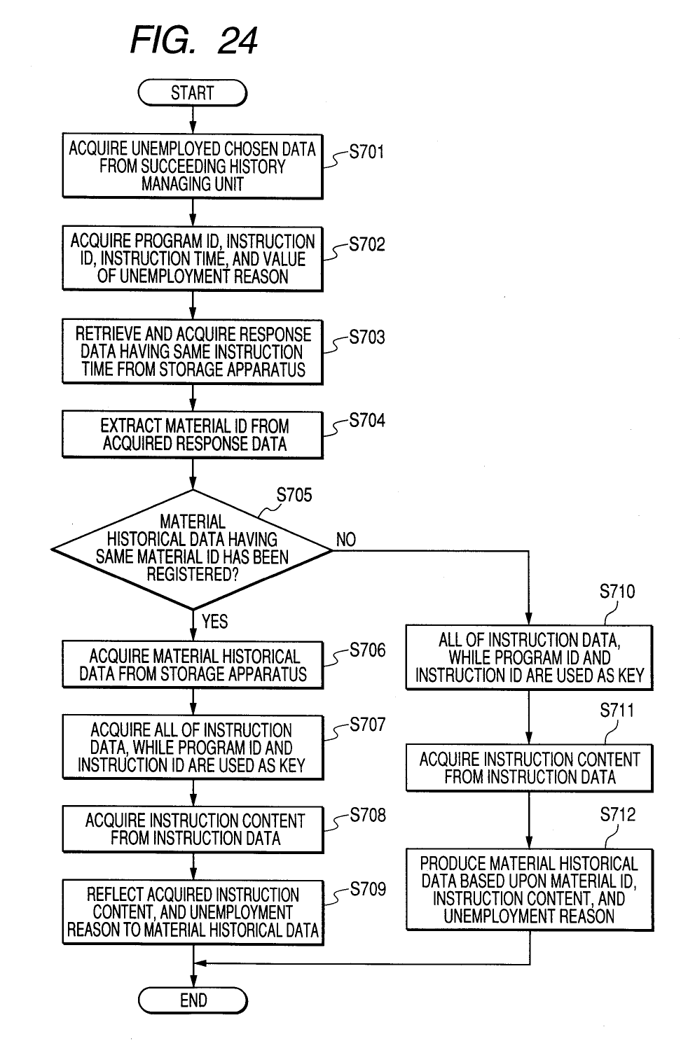

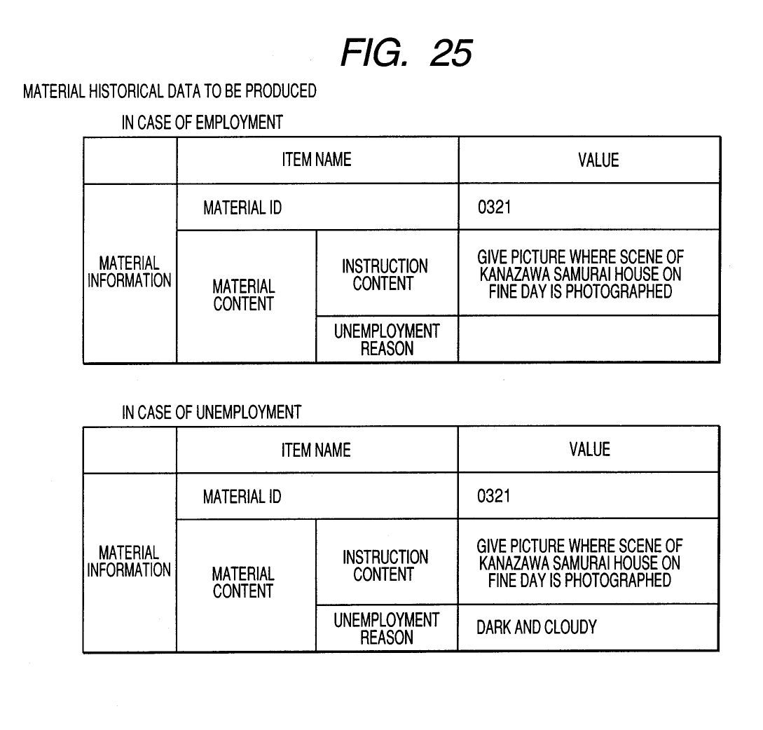

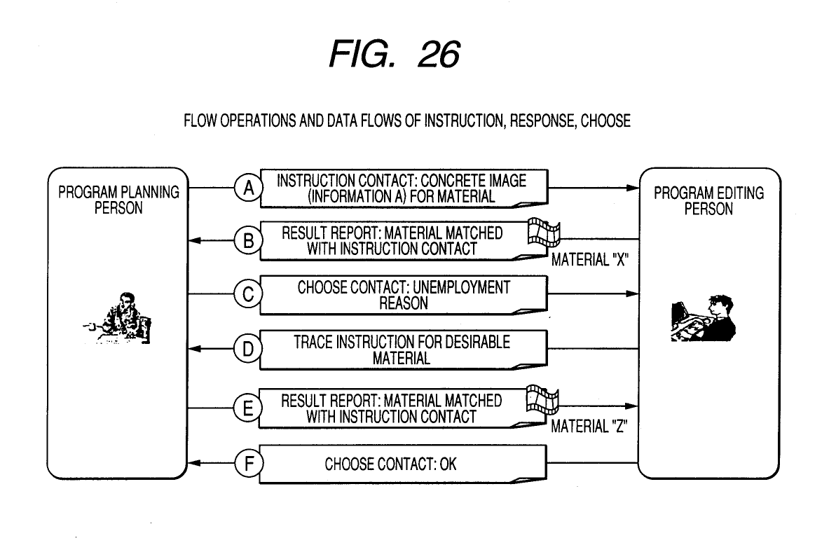

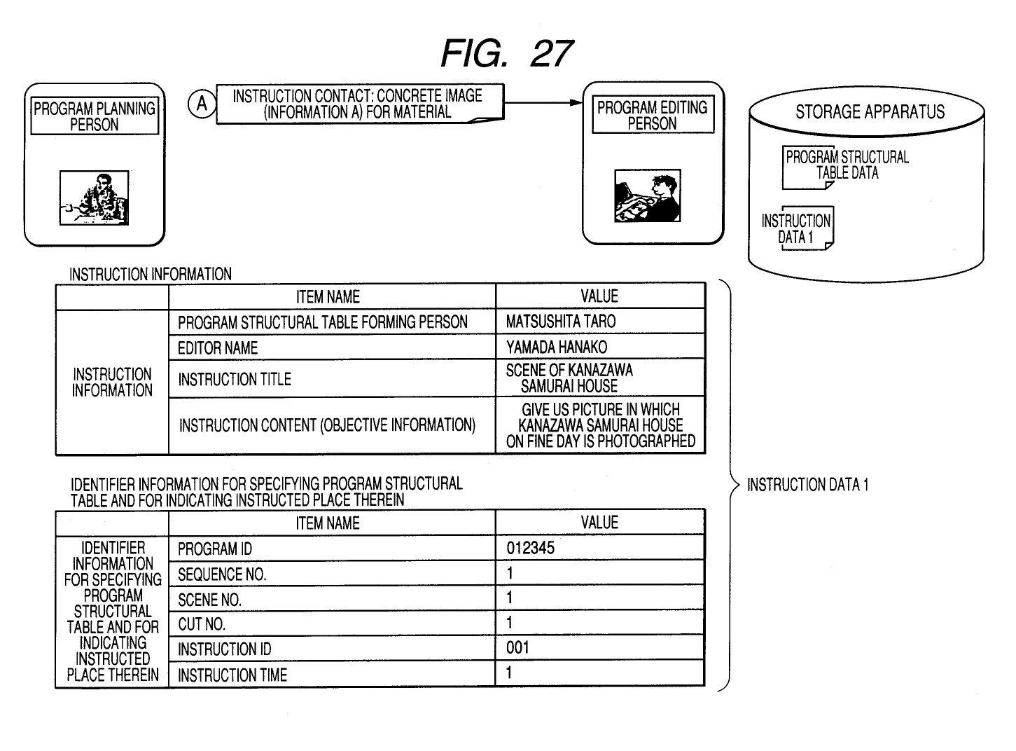

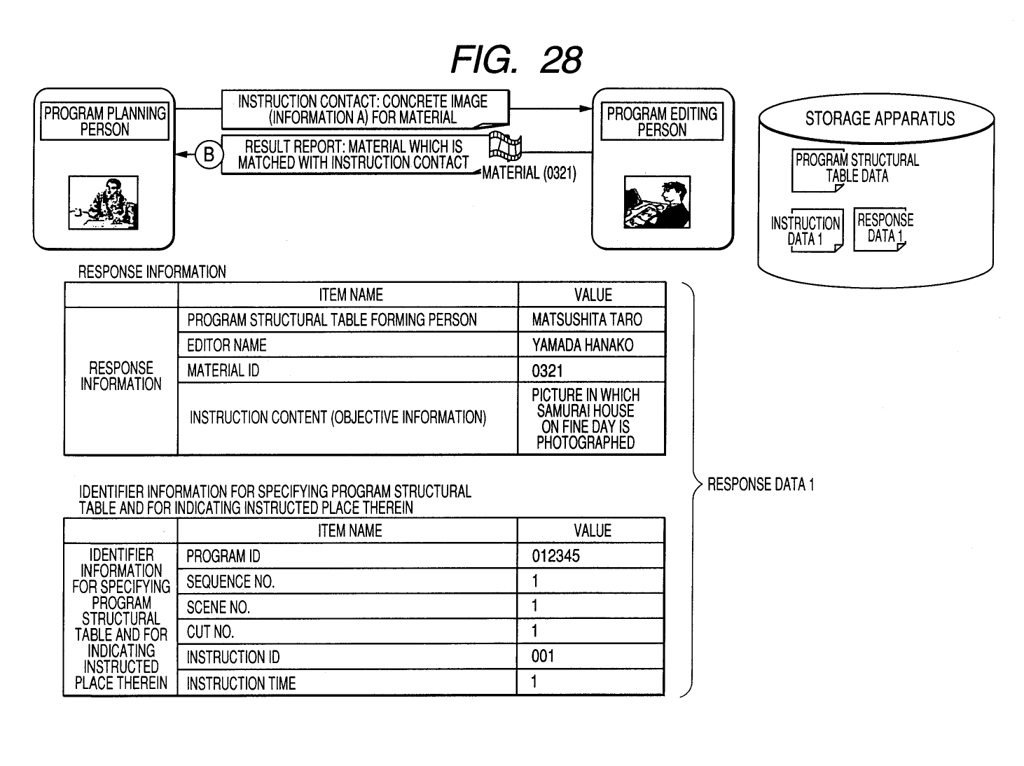

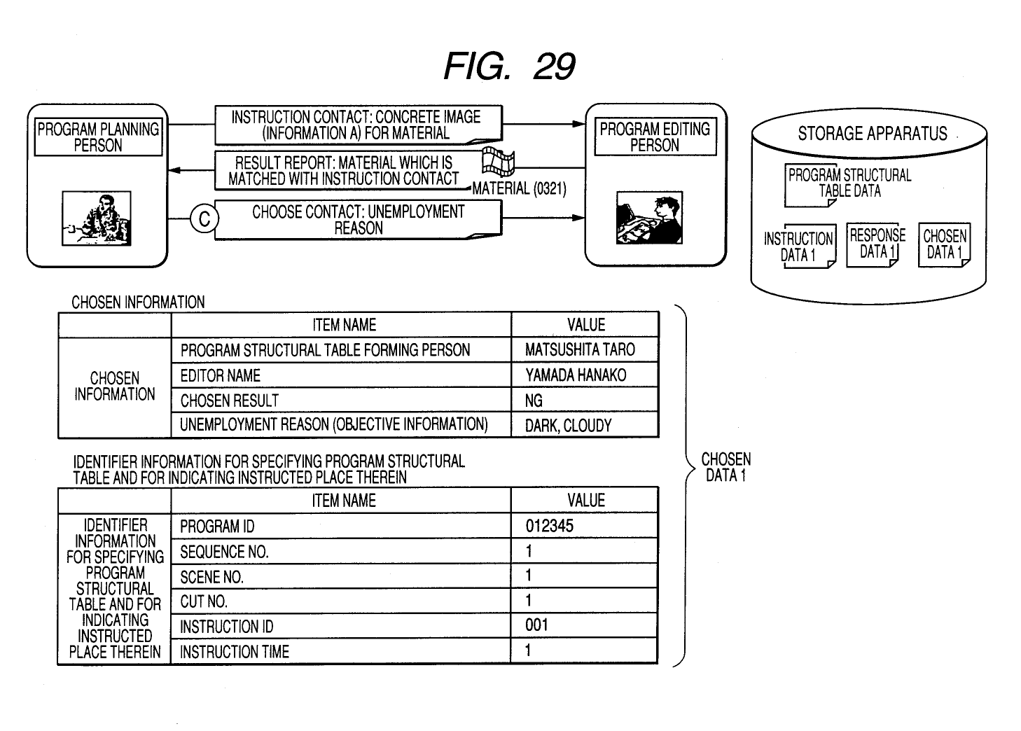

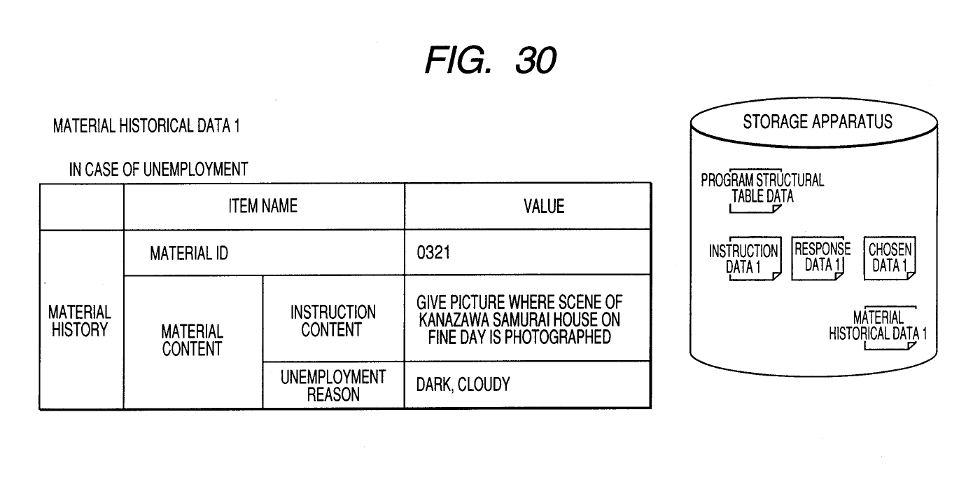

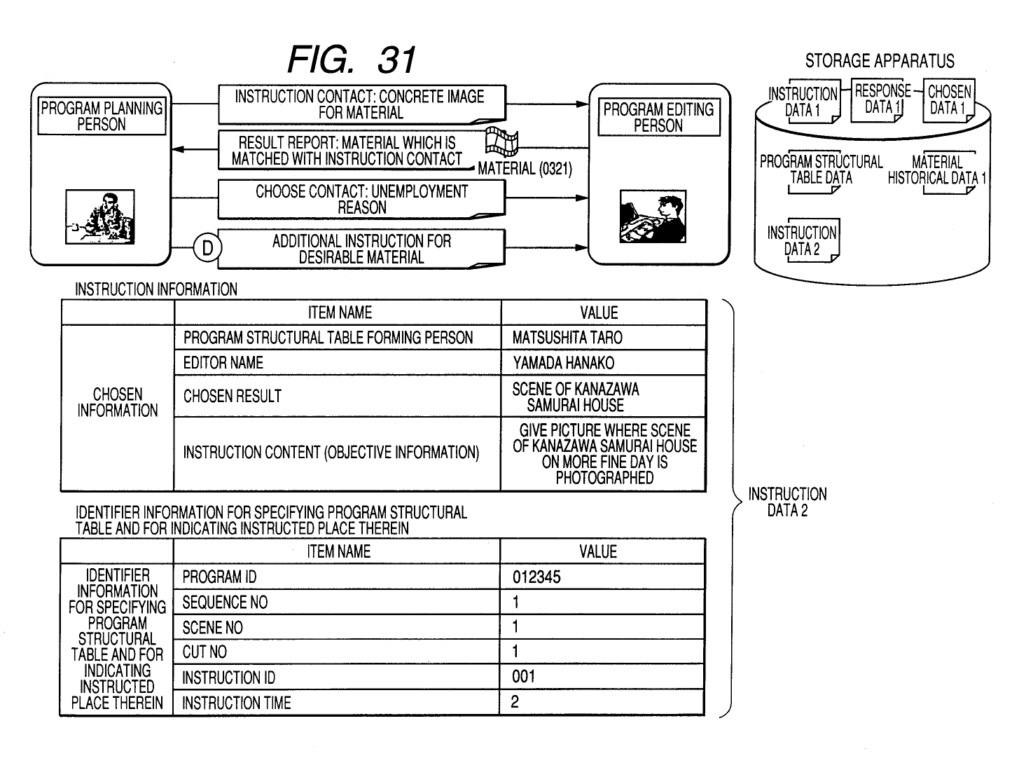

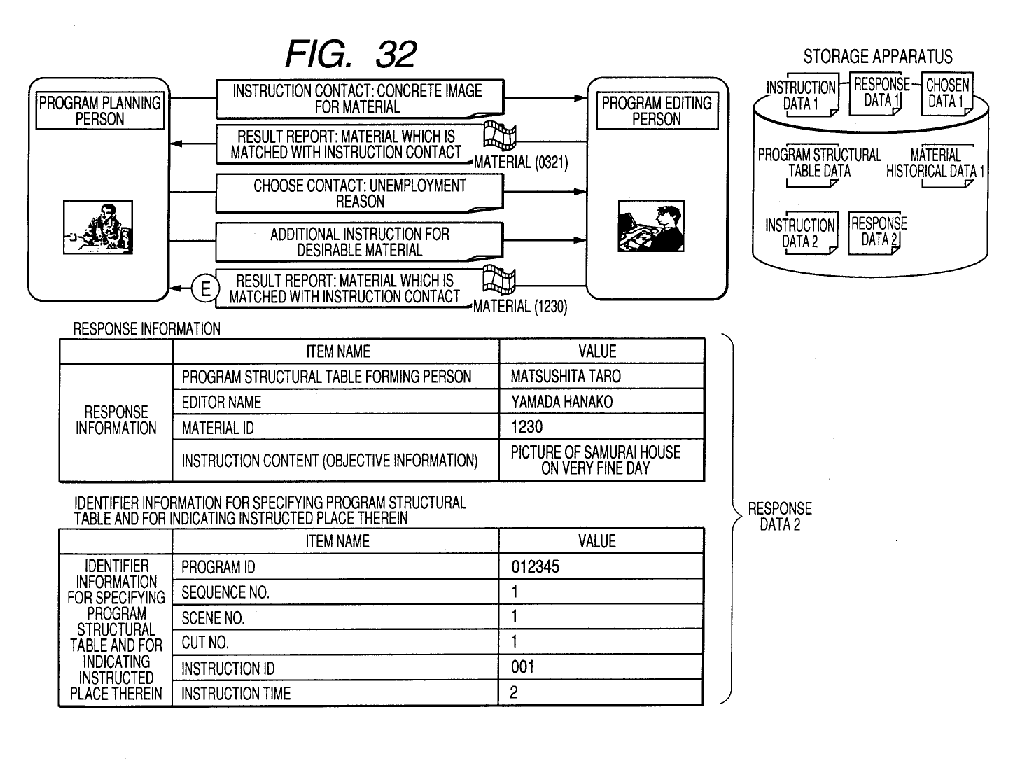

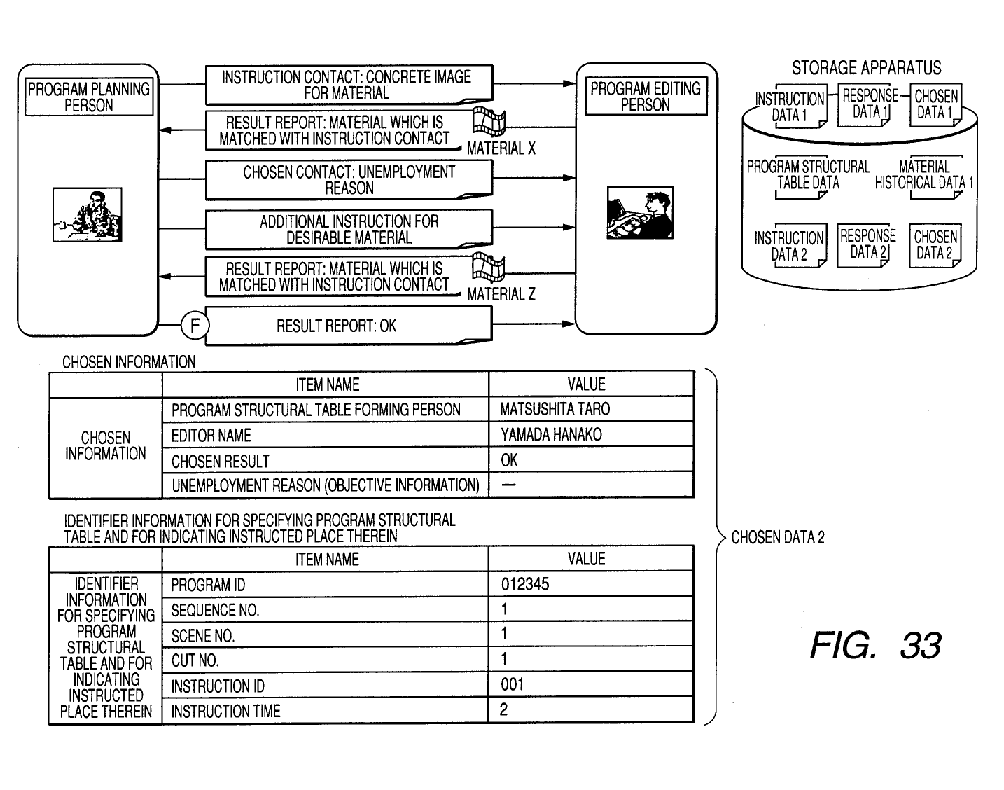

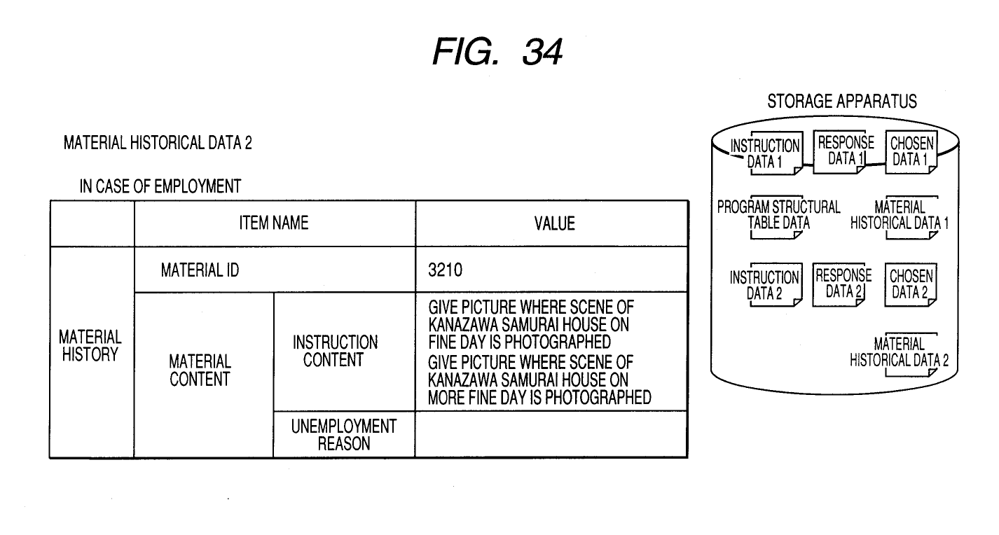

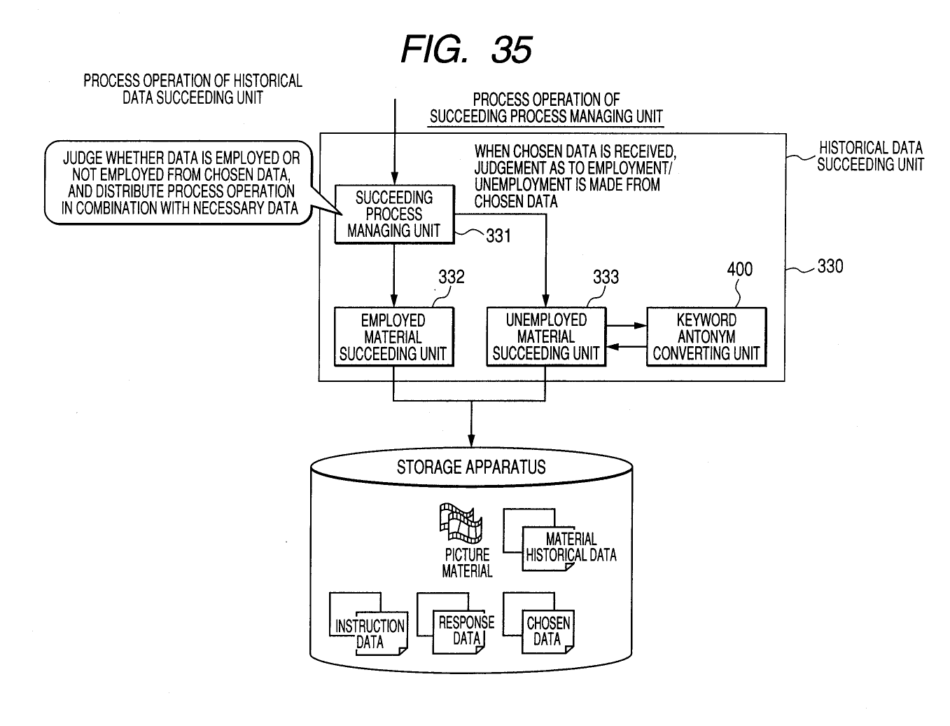

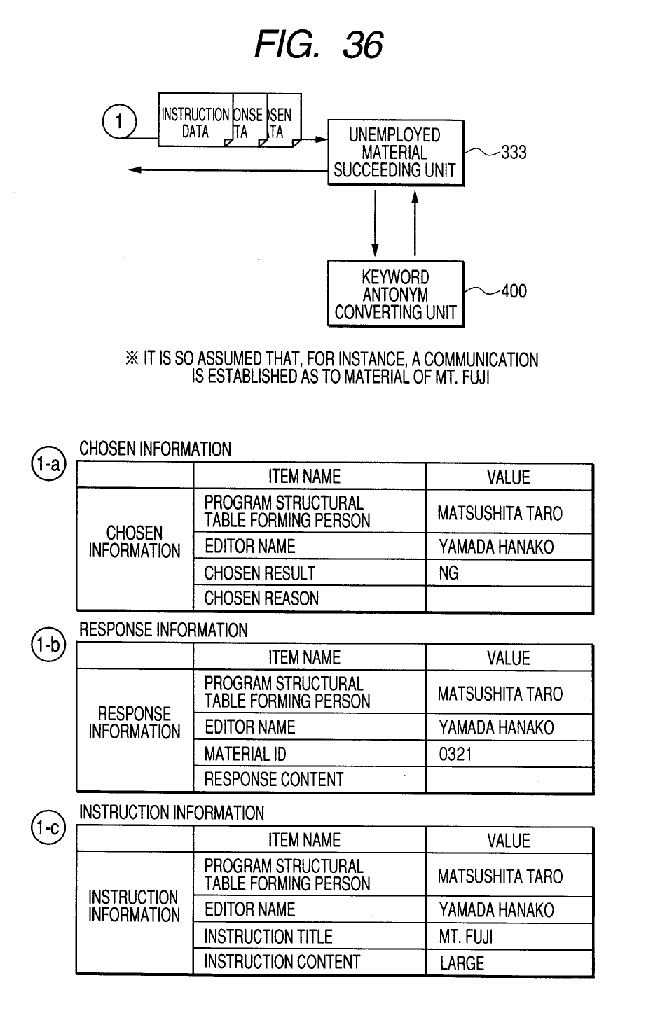

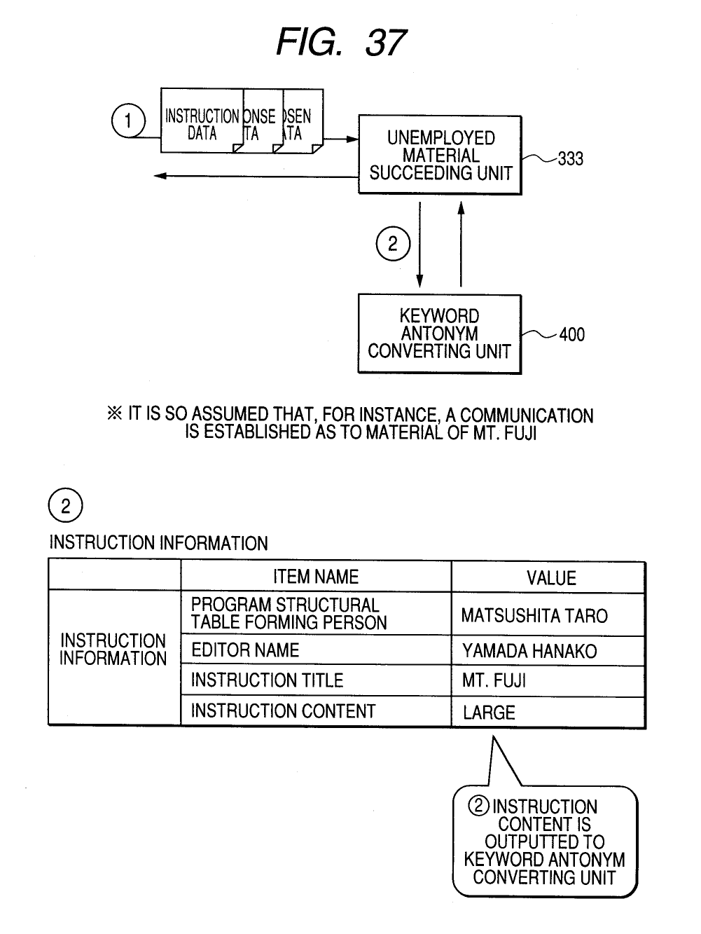

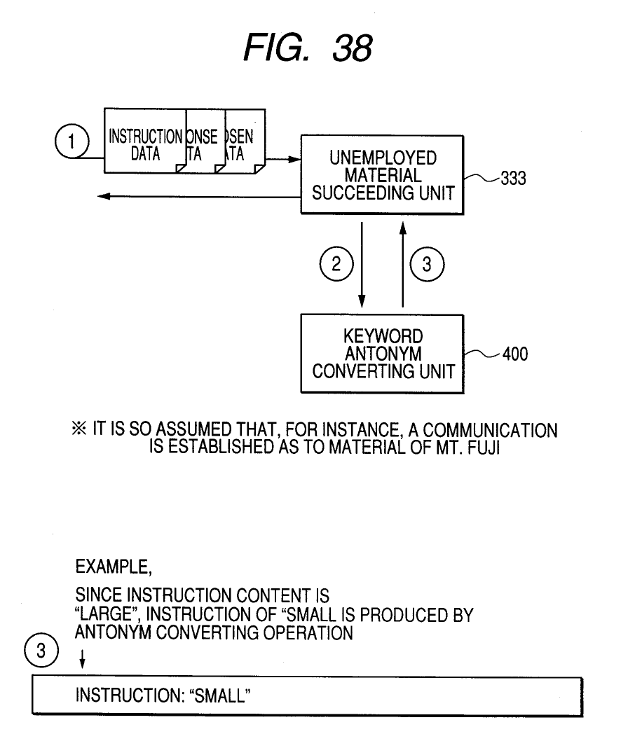

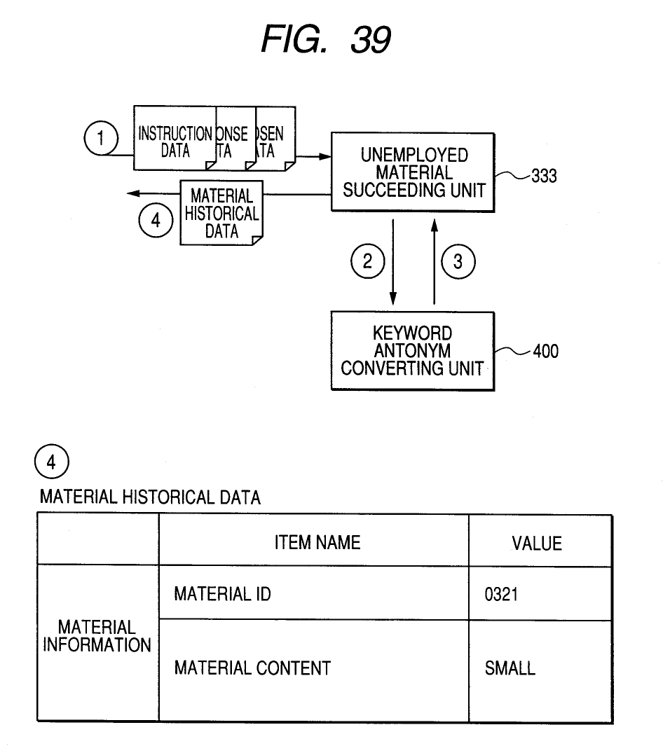

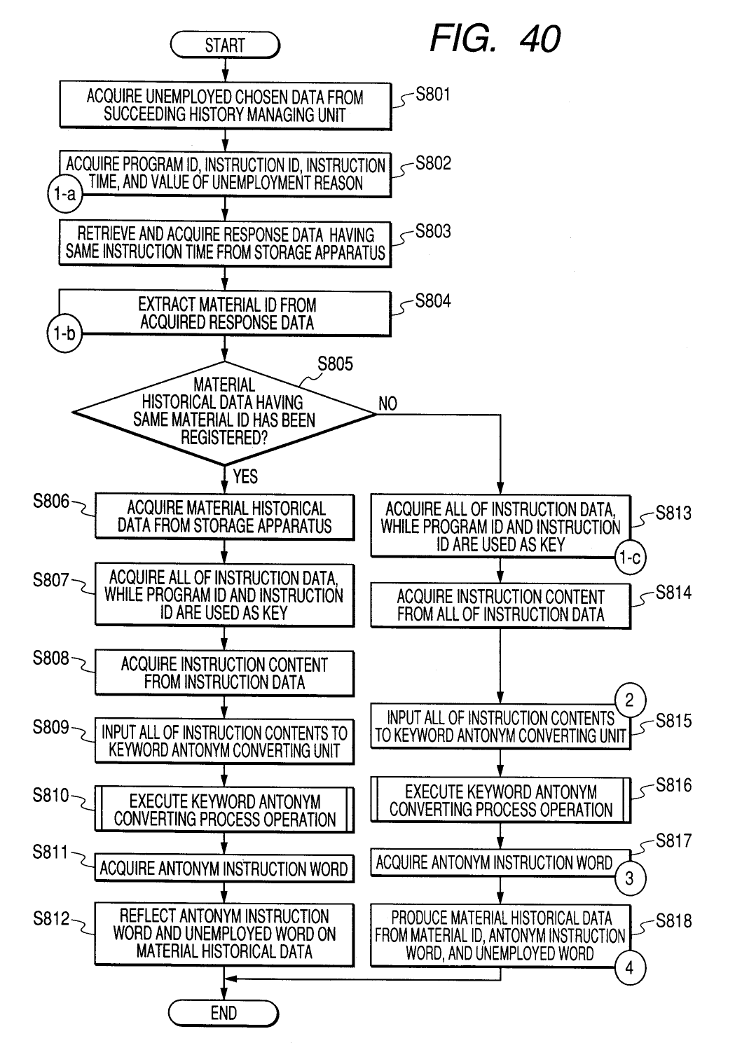

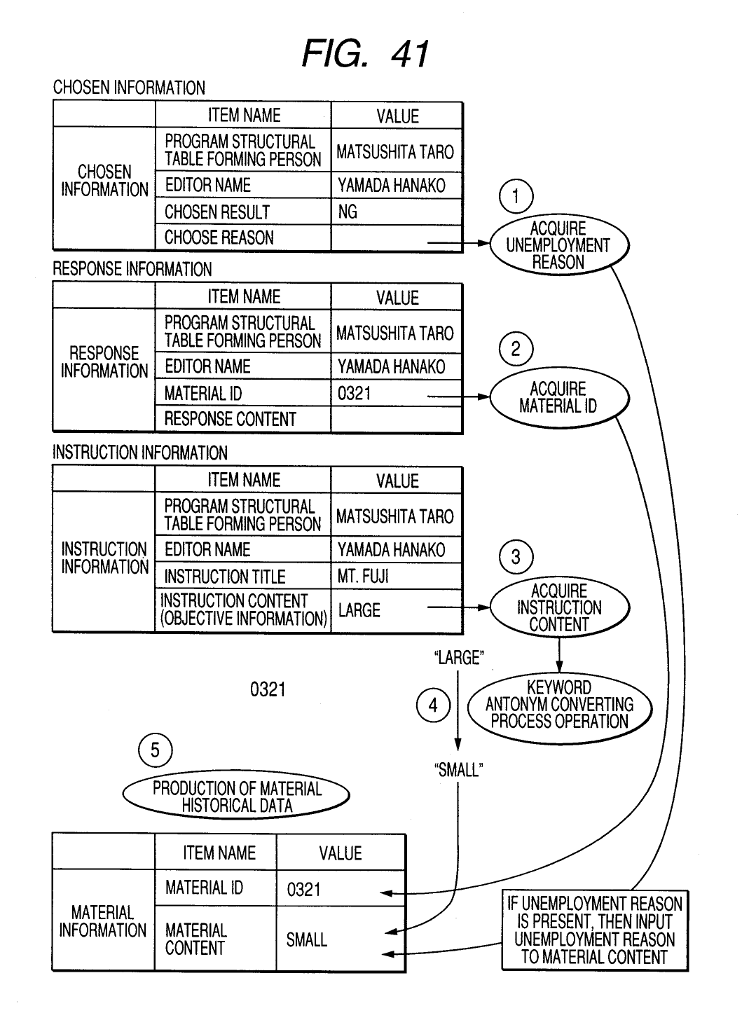

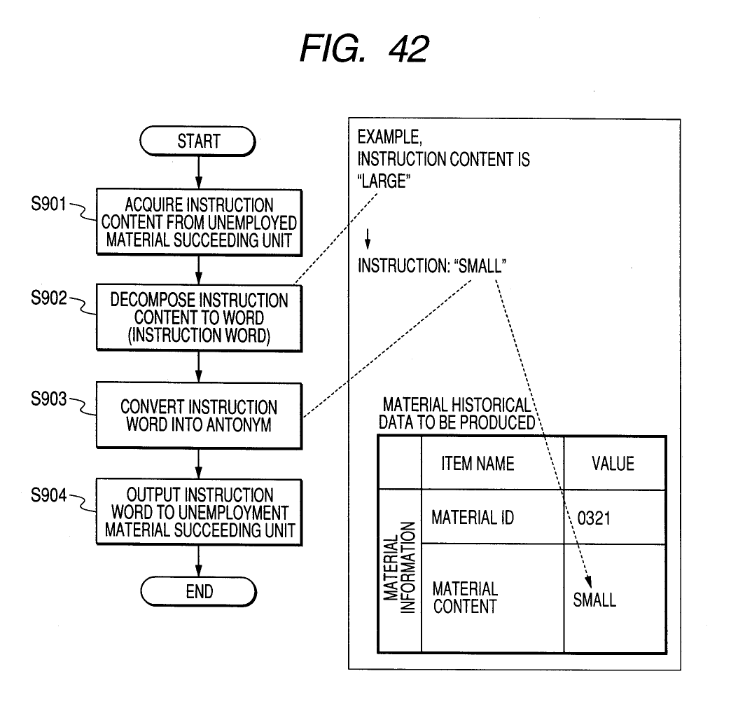

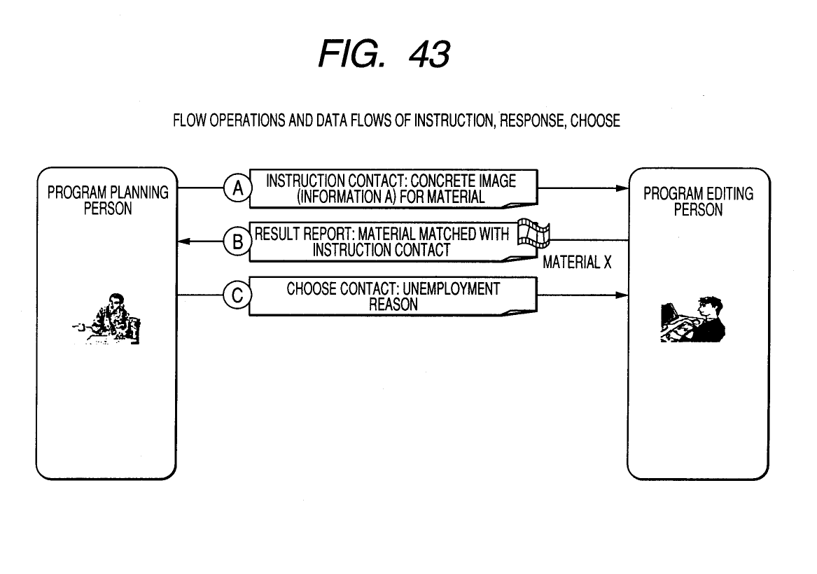

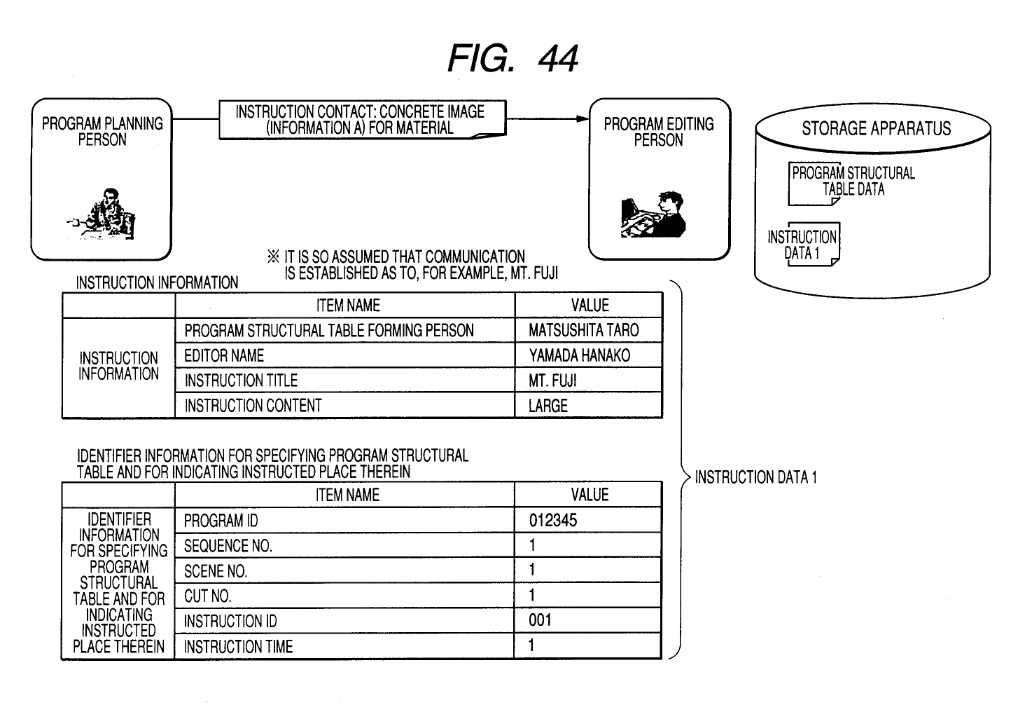

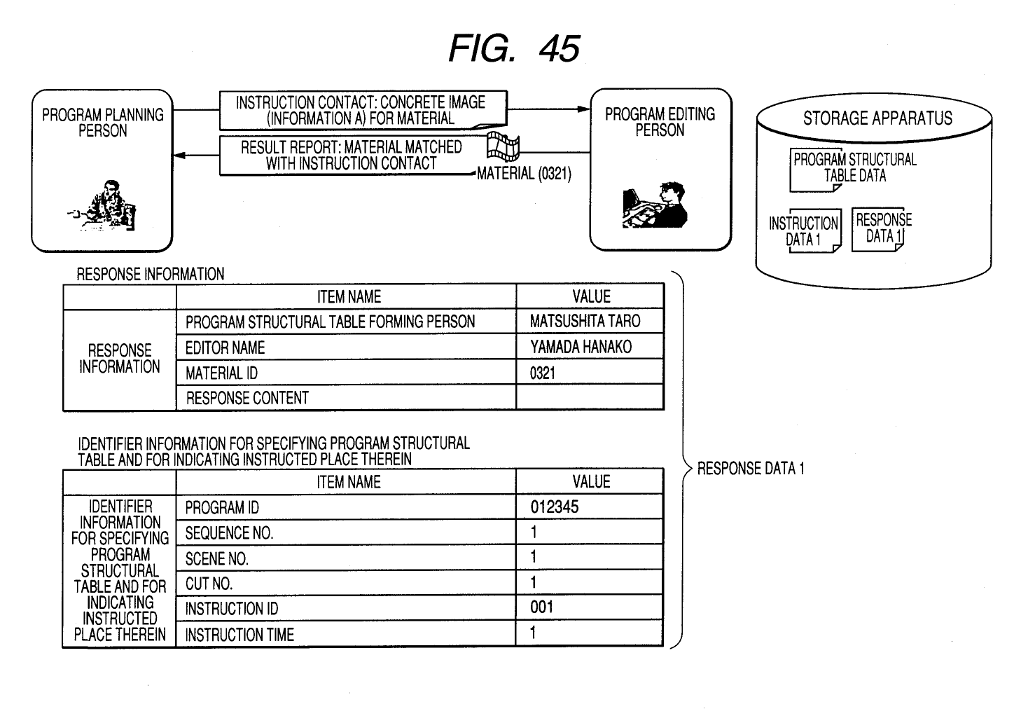

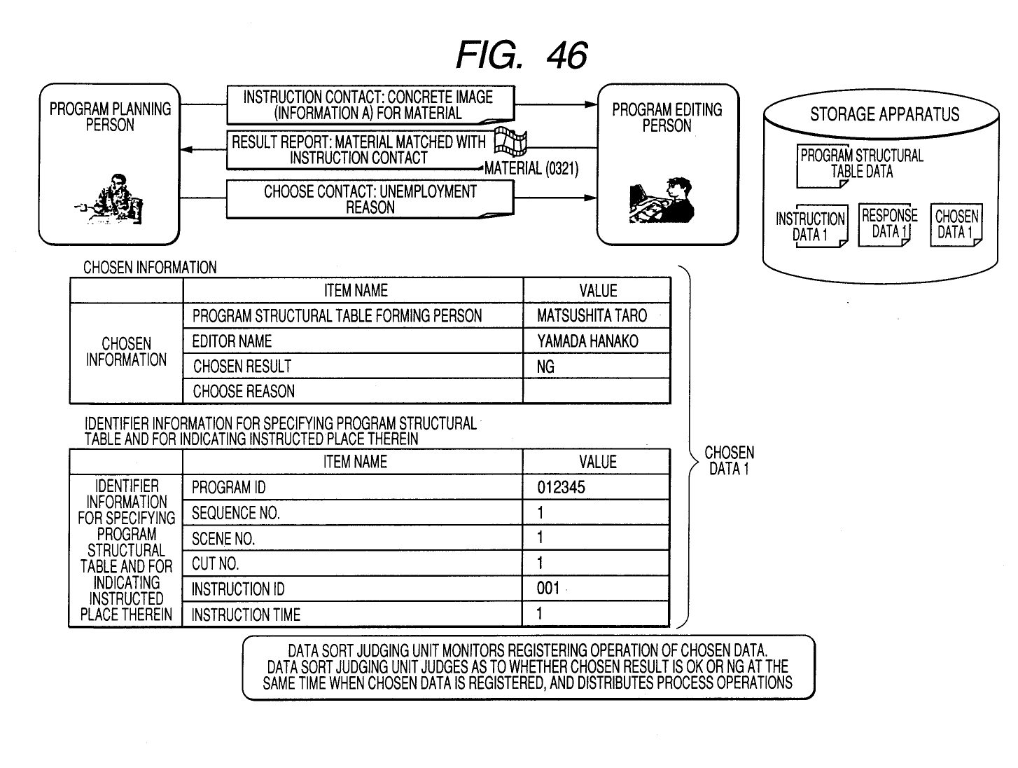

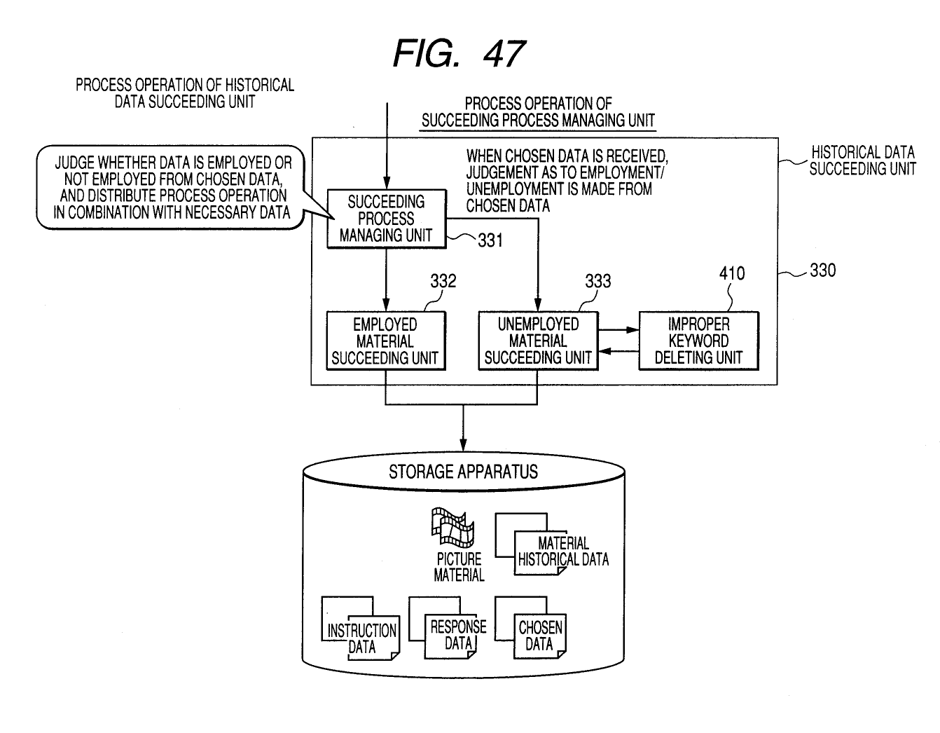

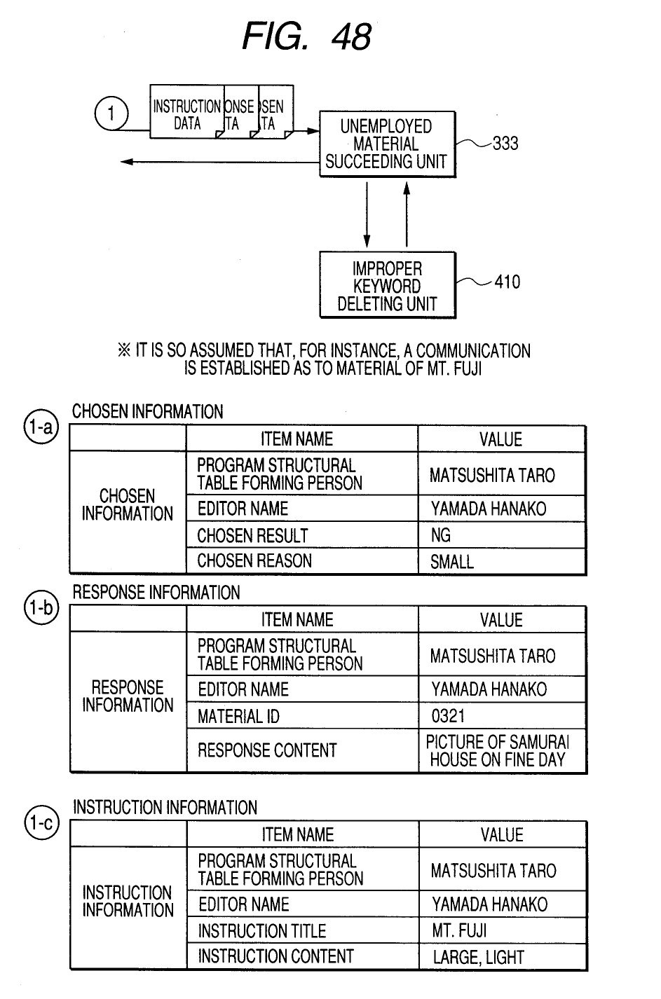

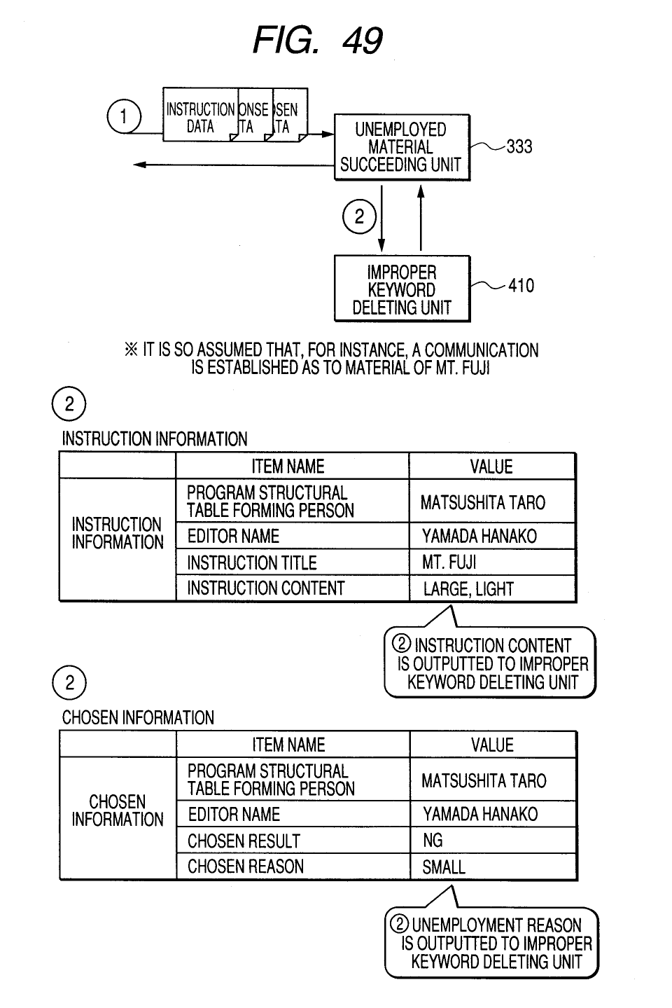

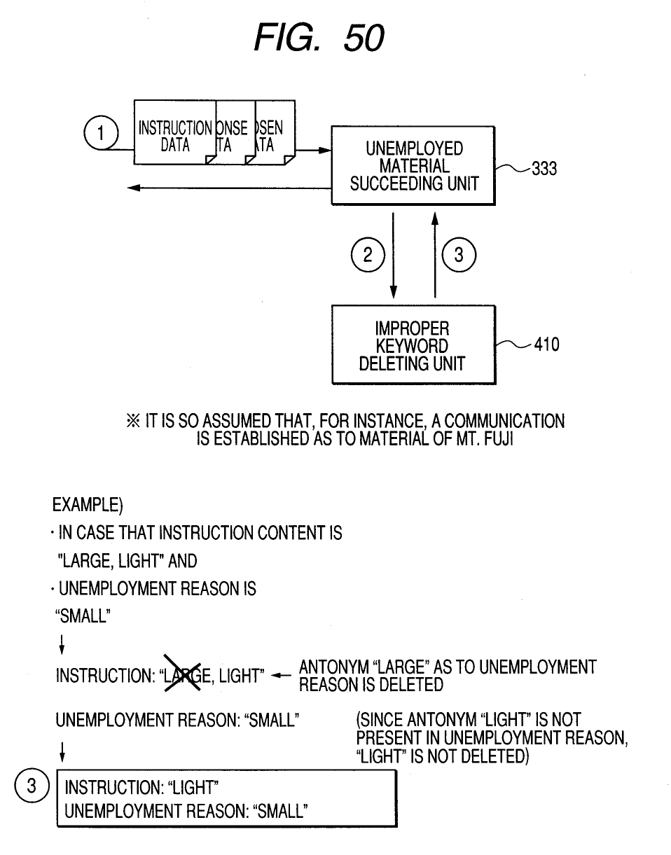

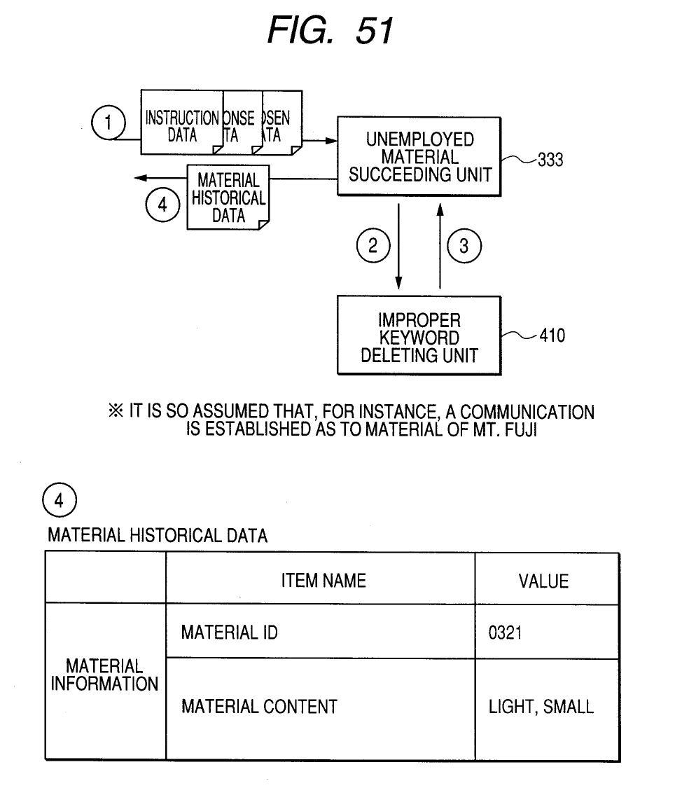

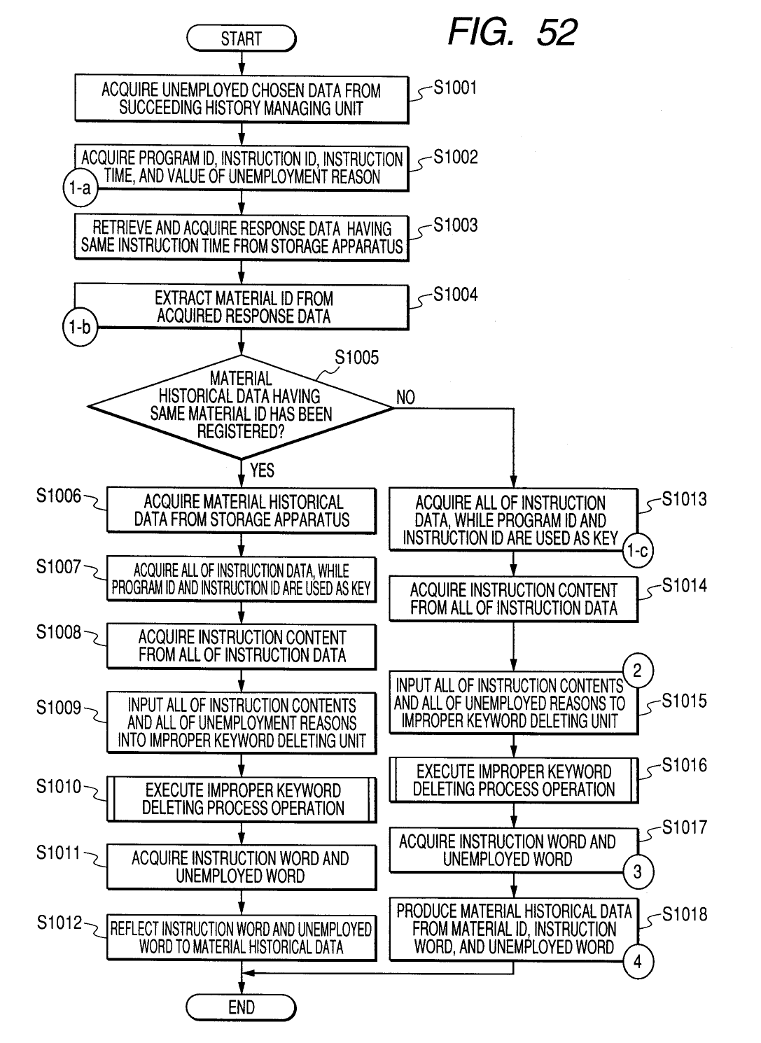

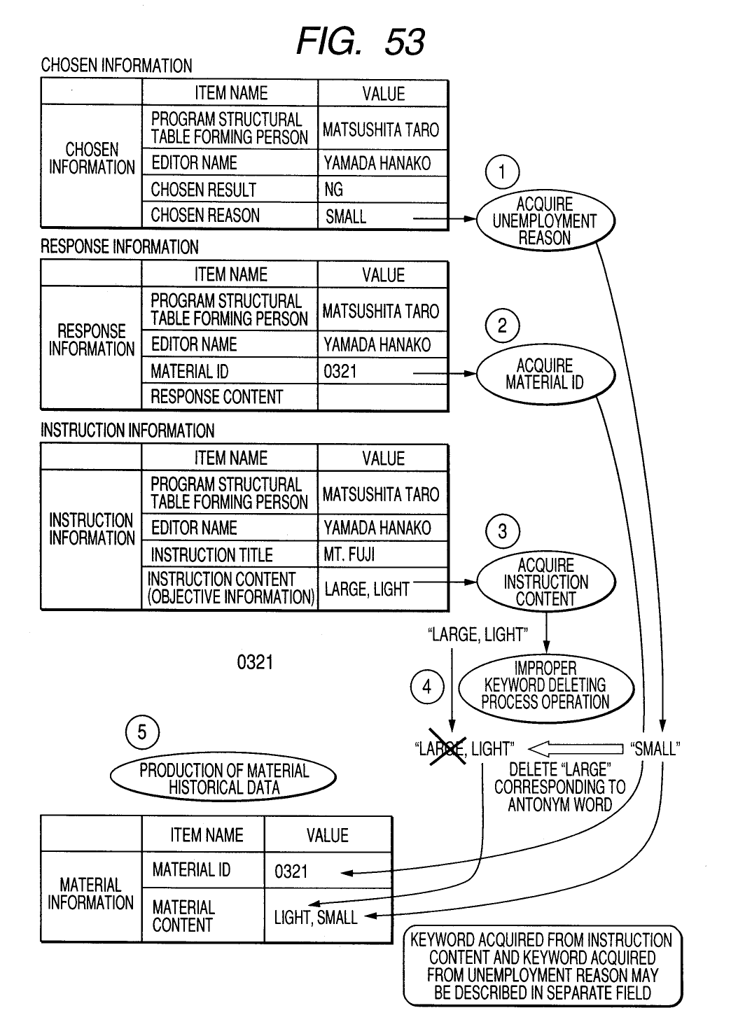

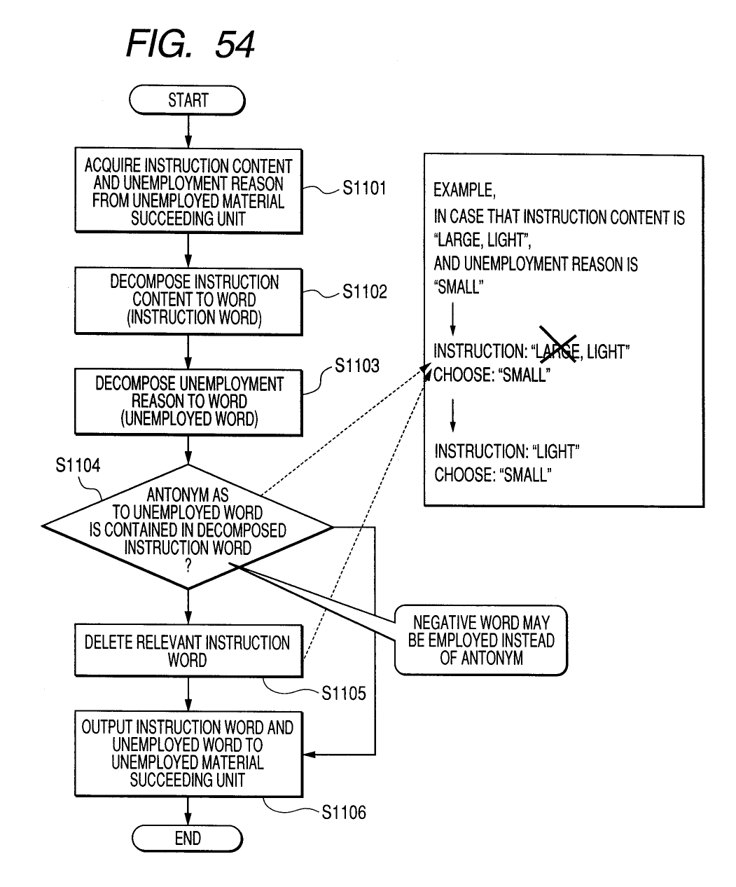

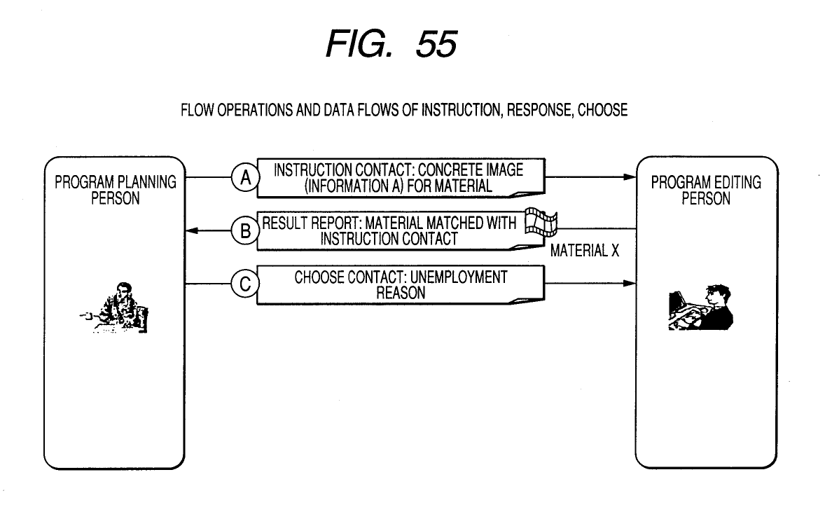

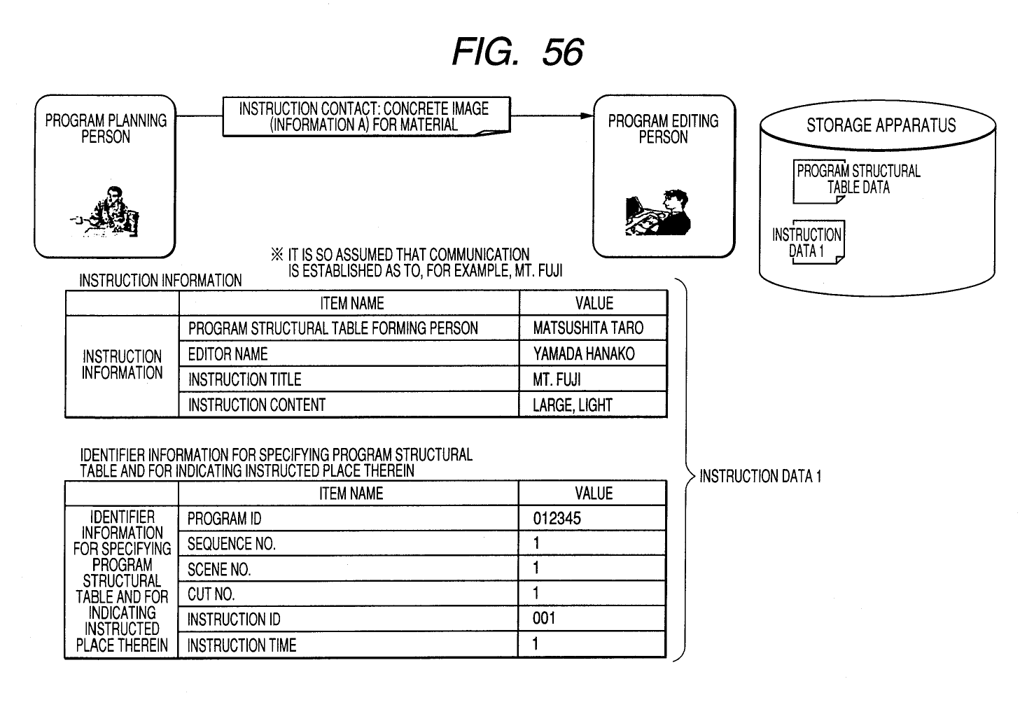

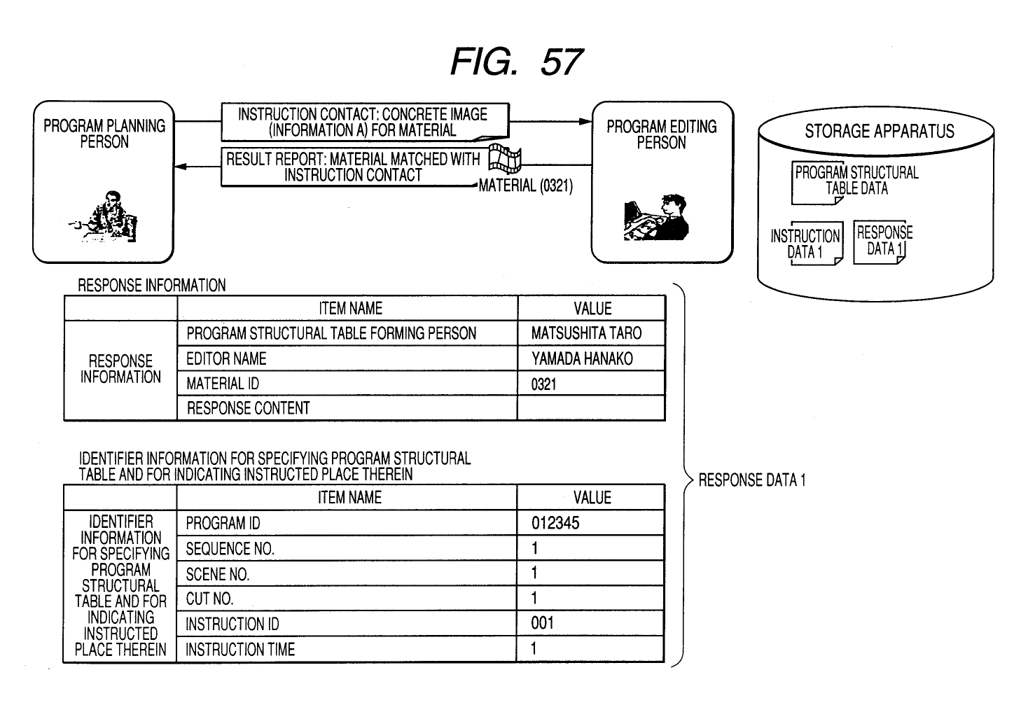

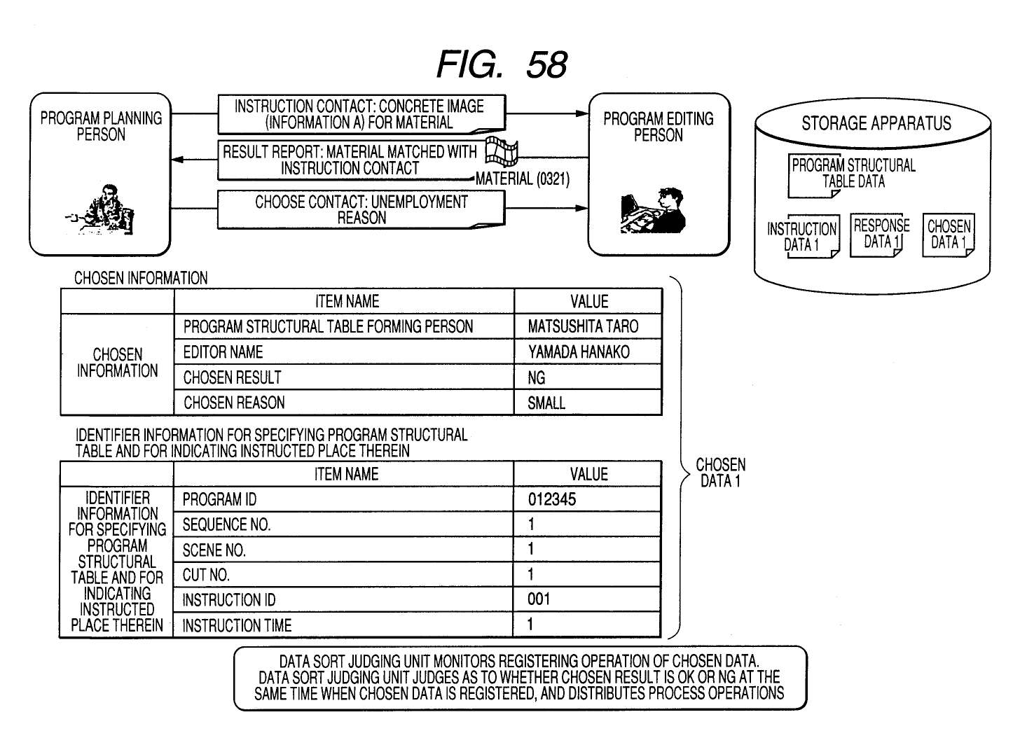

### BRIEF DESCRIPTION OF THE DRAWINGS

[FIG. 1] A diagram for indicating an arrangement of a program planning supporting system according to an embodiment 1 of the present invention.

[FIG. 2] A diagram for explaining a summary as to works and process flow operations, which are executed by employing the program planning supporting system according to the embodiment 1 of the present invention.

[FIG. 3] A schematic diagram for indicating a display example of a program structural table GUI screen which is produced based upon program structural table data.

[FIG. 4] A schematic diagram for conceptionally showing a data structure of the program structural table data.

[FIG. 5] A flow chart for indicating sequential process operations of the program planning supporting system in an instruction work.

[FIG. 6] A diagram for explaining process operations and data flows in the instruction work.

[FIG. 7] A schematic diagram for indicating a display example of an instruction data input screen.

[FIG. 8] FIG. 8 is a schematic diagram for conceptionally showing a data structure of instruction data.

[FIG. 9] A flow chart for indicating sequential process operations of the program planning supporting system in a response work.

[FIG. 10] A diagram for explaining process operations and data flows in the response work.

[FIG. 11] A schematic diagram for indicating a display example of a response data input screen.

[FIG. 12] A schematic diagram for conceptionally showing a data structure of response data.

[FIG. 13] A flow chart for indicating sequential process operations of the program planning supporting system in a choose work.

[FIG. 14] A diagram for explaining process operations and data flows in the choose work.

[FIG. 15] A schematic diagram for indicating a display example of a chosen data input screen.

[FIG. 16] A schematic diagram for conceptionally showing a data structure of the chosen data.

[FIG. 17] A diagram for representing an arrangement of a program planning supporting system according to an embodiment 2 of the present invention.

[FIG. 18] A diagram for explaining a summary as to works and flow process operations, which are executed by employing the program planning supporting system according to the embodiment 2 of the present invention.

[FIG. 19] A flow chart for indicating sequential process operations of the program planning supporting system in a material historical data registering operation.

[FIG. 20] A diagram for explaining process operations and data flows in the material historical data registering operation.

[FIG. 21] A diagram for showing a detailed internal arrangement of a historical data succeeding unit.

[FIG. 22] A flow chart for indicating sequential process operations of the program planning supporting system in a historical data succeeding operation.

[FIG. 23] A flow chart for showing sequential process operations for producing the material historical data in an employed material succeeding unit.

[FIG. 24] A flow chart for showing sequential process operations for producing the material historical data in an unemployed material succeeding unit.

[FIG. 25] A schematic diagram for conceptionally showing a data structure of the produced material historical data.

[FIG. 26] A schematic diagram for explaining issuing/responding operations of instructions, responses, and choices, and also, data flows performed between a program planning person and a program editing person.

[FIG. 27] A schematic diagram (first time) for showing conditions under which instruction data is transmitted from the program planning person to the editing person.

[FIG. 28] A schematic diagram (first time) for indicating conditions under which response data is transmitted from the program editing person to the program planning person.

[FIG. 29] A schematic diagram (first time) for representing conditions under which chosen data is transmitted from the program planning person to the program editing person.

[FIG. 30] A schematic diagram (first time) for conceptionally indicating a data structure of material historical data produced based upon the chosen data.

[FIG. 31] A schematic diagram (second time) for showing conditions under which instruction data is transmitted from the program planning person to the program editing person.

[FIG. 32] A schematic diagram (second time) for indicating conditions under which response data is transmitted from the program editing person to the program planning person.

[FIG. 33] A schematic diagram (second time) for representing conditions under which chosen data is transmitted from the program planning person to the program editing person.

[FIG. 34] A schematic diagram (second time) for conceptionally indicating a data structure of material historical data produced based upon the chosen data.

[FIG. 35] A diagram for showing a detailed internal structure of a historical data succeeding unit of a program planning supporting system according to an embodiment 3 of the present invention.

[FIG. 36] A diagram for explaining process operations and data flows in a historical data succeeding unit containing a keyword antonym converting unit.

[FIG. 37] A diagram for explaining process operations and data flows in the historical data succeeding unit containing the keyword antonym converting unit.

[FIG. 38] A diagram for explaining process operations and data flows in the historical data succeeding unit containing the keyword antonym converting unit.

[FIG. 39] A diagram for explaining process operations and data flows in the historical data succeeding unit containing the keyword antonym converting unit.

[FIG. 40] A flow chart for describing sequential process operations for producing material historical data in an unemployed material succeeding unit.

[FIG. 41] A diagram for schematically showing concrete flows of data in the unemployed material succeeding unit.

[FIG. 42] A flow chart for explaining keyword antonym converting sequential process operations of the keyword antonym converting unit.

[FIG. 43] A schematic diagram for explaining issuing/responding operations of instructions, responses, and choices, and also, data flows performed between a program planning person and a program editing person.

[FIG. 44] A schematic diagram (first time) for showing conditions under which instruction data is transmitted from the program planning person to the program editing person.

[FIG. 45] A schematic diagram (first time) for indicating conditions under which response data is transmitted from the program editing person to the program planning person.

[FIG. 46] A schematic diagram (first time) for representing conditions under which chosen data is transmitted from the program planning person to the program editing person.

[FIG. 47] A diagram for showing a detailed internal structure of a historical data succeeding unit of a program planning supporting system according to an embodiment 4 of the present invention.

[FIG. 48] A diagram for explaining process operations and data flows in an unemployed material succeeding unit containing an improper keyword deleting unit.

[FIG. 49] A diagram for explaining process operations and data flows in the unemployed material succeeding unit containing the improper keyword deleting unit.

[FIG. 50] A diagram for explaining process operations and data flows in the unemployed material succeeding unit containing the improper keyword deleting unit.

[FIG. 51] A diagram for explaining process operations and data flows in the unemployed material succeeding unit containing the improper keyword deleting unit.

[FIG. 52] A flow chart for describing sequential process operations for producing material historical data in the unemployed material succeeding unit.

[FIG. 53] A diagram for schematically showing concrete flows of data in the unemployed material succeeding unit.

[FIG. 54] A flow chart for explaining sequential process operations for deleting an improper keyword by the improper keyword deleting unit.

[FIG. 55] A schematic diagram for explaining issuing/responding operations of instructions, responses, and choices, and also, data flows performed between a program planning person and a program editing person.

[FIG. 56] A schematic diagram (first time) for showing conditions under which instruction data is transmitted from the program planning person to the program editing person.

[FIG. 57] A schematic diagram (first time) for indicating conditions under which response data is transmitted from the program editing person to the program planning person.

[FIG. 58] A schematic diagram (first time) for representing conditions under which chosen data is transmitted from the program planning person to the program editing person.

### DESCRIPTION OF REFERENCE NUMERALS AND SIGNS

11 instruction data inputting unit
12 instruction data transmitting unit
21 response data receiving unit
22 response data display unit;
31 chosen data inputting unit
32 chosen data transmitting unit
40 transmitting/receiving unit (structure work terminal)
51 instruction data receiving unit
52 instruction data display unit
61 response data inputting unit
62 response data transmitting unit
71 chosen data receiving unit
72 chosen data display unit;
80 transmitting/receiving unit (response work terminal)
91 program structure table data
92 instruction data
93 response data
94 chosen data
95 picture material data
100 structure work terminal
200 response work terminal
300 storage apparatus
310 material historical data managing unit
320 data sort judging unit
330 historical data succeeding unit
331 succeeding process managing unit
332 employed material succeeding unit
333 unemployed material succeeding unit
400 keyword antonym converting unit
410 improper keyword deleting unit

### BEST MODE FOR CARRYING OUT THE INVENTION

Referring now to accompanying drawings, a detailed description is made of program planning supporting systems according to embodiments of the present invention. It should be understood that the same reference numerals are employed as those for denoting structural elements having the same functions in all of these drawings used to explain the embodiments, and explanations thereof are not repeatedly made.

### EMBODIMENT 1

FIG. 1 is a diagram for representing an arrangement of a program planning supporting system according to an embodiment 1 of the present invention. The program planning supporting system shown in FIG. 1 is equipped with a structure work terminal 100, a response work terminal 200, and a storage apparatus 300. The structure work terminal 100 performs a structure work of a program structural table which is required for planning a program. The response work terminal 200 performs an edit work of the program structural table in response to an editing instruction which is required for the structure work of the program structural table. The storage apparatus 300 stores thereinto the program structural table.

The structure work terminal 100 is provided with an instruction data inputting unit 11, an instruction data transmitting unit 12, a response data receiving unit 21, a response data display unit 22, a chosen data input unit 31, a chosen data transmitting unit 32, and a transmitting/receiving unit 40. The instruction data inputting unit 11 inputs instruction data required for an editing instruction. The instruction data transmitting unit 12 transmits inputted instruction data via a transmitting/receiving unit 40 (will be explained later) to the storage apparatus 300 so as to register thereinto the transmitted instruction data. Also, the instruction data transmitting unit 12 similarly transmits identifier information related to this instruction data via the transmitting/receiving unit 40 to the response work terminal 200. Also, the response data receiving unit 21 receives identifier information related to response data which is registered to the storage apparatus 300 by the response work terminal 200 via the transmitting/receiving unit 40, and acquires the received response data from the storage apparatus 300 to transmit the acquired response data to the response data display unit 22. The response data display unit 22 displays thereon the response data received from the response data receiving unit 21 in relation to the program structural table. Also, the chosen data inputting unit 31 inputs chosen data (result of judging as to whether or not data is chosen) which is required to choose the editing work performed by the response work terminal 200. The chosen data transmitting unit 32 transmits the inputted chosen data via the transmitting/receiving unit 40 to the storage apparatus 300 so as to store the transmitted chosen data in the storage apparatus 300. Also, the chosen data transmitting unit 32 similarly transmits identifier information related to this chosen data via the transmitting/receiving unit 40 to the response work terminal 200. Also, the transmitting/receiving unit 40 is constituted by a data communication apparatus, and controls transmitting and receiving operations of data between the structure work terminal 100 and either the storage apparatus 300 or the response work terminal 200.

The response work terminal 200 is provided with an instruction data receiving unit 51, an instruction data display unit 52, a response data inputting unit 61, a response data transmitting unit 62, a chosen data receiving unit 71, a chosen data display unit 72, and a transmitting/receiving unit 80. The instruction data receiving unit 51 receives identifier information related to the instruction data formed by the structure work terminal 100 via the transmitting/receiving unit 80 (will be explained later). Also, the instruction data receiving unit 51 acquires the corresponding instruction data from the storage apparatus 300, and transmits the acquired instruction data to the instruction data display unit 52. The instruction data display unit 52 displays thereon the instruction data received by the instruction data receiving unit 51 in relation to the program structure table. Also, the response input unit 61 inputs response data (which is required in edit work) with respect to the instruction data transmitted by the structure work terminal 100. The response transmitting unit 62 transmits the inputted response data via the transmitting/receiving unit 80 to the storage apparatus 300 so as to register the transmitted response data in the storage apparatus 300. Also, the response data transmitting unit 62 similarly transmits identifier information related to this response data via the transmitting/receiving unit 80 to the structure work terminal 100. Also, the chosen data receiving unit 31 receives identifier information related to the chosen data formed in the structure work terminal 100 via the transmitting/receiving unit 31. The chosen data receiving unit 31 acquires the corresponding chosen data from the storage apparatus 300 and transmits the acquired chosen data to the chosen data display unit 72. The chosen data display unit 72 displays thereon the program structural data received by the chosen data receiving unit 71. Also, the transmitting/receiving unit 80 is arranged by a data communication apparatus, and controls transmitting and receiving operations of data between the response work terminal 200 and either the storage apparatus 300 or the structure work terminal 100.

The storage apparatus 300 is constructed of a memory, and stores thereinto various sorts of data such as program structural table data 91 for displaying the program structural table, instruction data 92, response data 93, chosen data 94, and picture material data 95. In this case, the picture material data 95 corresponds to picture data which is recorded by using a video camera, or the like during material collection. A program editing person selects proper picture data from this picture material, and processes (e.g., edits) the selected picture data in response to an instruction issued from a program planning person. It should also be understood that detailed contents as the program structure data, the instruction data, the response data, and the chosen data will be explained later.

Next, a description is made of program planning supporting operations by the program planning supporting system with employment of the above-explained arrangement.

FIG. 2 is a diagram for explaining a summary as to works and process flow operations, which are executed by employing the program planning supporting system according to the embodiment 1 of the present invention. First of all, a program planning person such as a producer and an editor issues a work instruction with respect to a program editing person from the structure work terminal 100, while the work instruction is to select, or edit a necessary image. An instruction content is registered as instruction data in the storage apparatus 300, and at the same time, identifier information of this instruction data is transmitted as an instruction contact to the response work terminal 200 (instruction work).

Next, the program editing person such as an editor and a staff member receives the instruction contact by the response work terminal 200, and further, acquires the instruction data from the storage apparatus 300 so as to confirm the instruction content. When the program editing person executes the edit work in accordance with the instruction content by the response work terminal and the work is accomplished, the work content is registered as response data in the storage apparatus 300. At the same time, identifier information of this response data is transmitted as a work result report to the structure work terminal 100 (response work).

Finally, the program planning person receives the result report by the structure work terminal 100, and further, acquires the response data from the storage apparatus 300 so as to confirm a content of the response work with reference to the instruction. The program planning person determines as to whether or not this work content is actually used (chosen) in a program. The determined content is registered as chosen data in the storage apparatus 300, and, at the same time, identifier information of this chosen data is transmitted as a chosen contact to the response work terminal 200 (chose work). As a consequence, a program editing person of the response work terminal 200 acquires the chosen data from the storage apparatus 300, so that the program editing person can grasp a result of choosing/not choosing work with respect to the response work such as the selecting and editing works of the material, which are carried out by the own program editing person.

Now, a description is made of a program structural table which causes instruction data, response data, and chosen data to be related to each other. When a program planning person issues an instruction such as an editing instruction with respect to a program editing person, and when the program editing person performs a work in response to the content of the instruction, the program planning person and the program editing person start the works from a GUI (Graphical User Interface) screen which is produced based upon program structural table data. FIG. 3 is a schematic diagram for indicating a display example of a program structural table GUI screen which is produced based upon program structural table data. This GUI screen corresponds to such a screen which is displayed on any one of a structure work terminal and a response work terminal. As indicated in the drawing, a program is sequentially classified in time sequence from a structure of this program, and the sequence is furthermore classified into a plurality of scenes. While a scene is arranged by a plurality of cuts, a program structure is accomplished by arranging proper pictures and proper images with respect to all of the cuts of the program structural table. On this GUI screen, each of the work screens is initiated by clicking buttons arranged in cut columns.

For instance, when the program planning person clicks a new instruction input button provided in a cut content column, a control operation is advanced to the instruction data input unit 11, and then, the present screen is moved to an instruction data input screen on which an instruction work with respect to this cut is performed, so that a detailed instruction can be entered. In a cut 1 of a scene 1, such an instruction for requesting an image of “scene of KANAZAWA SAMURAI HOUSE” has already been inputted as an editing instruction. In this embodiment 1, indications of these items are discriminated from each other in different colors in response to stages of an instruction work, a response work, and a choose work, so that the present work stage can be easily grasped in a visual manner.

Also, when the program editing person clicks a content display button present in the editing instruction column, the control operation is advanced to both the instruction data receiving unit 51 and the instruction data display unit 52, and the present screen is moved to a content display screen of the instruction data, so that a detailed instruction content can be grasped. Furthermore, when the program editing person clicks a response input button present on the editing instruction column, the control operation is advanced to the response data input unit 61, and the present screen is moved to a response data input screen, so that a detailed work such as an editing operation can be performed. FIG. 4 is a schematic diagram for conceptionally showing data structures of program structural table data. The above-explained GUI screen is constituted by respective program structural table data as shown in this drawing. It should be understood that since various sorts of works such as an instruction work, a response work, and a choose work are carried out with respect to the program structural table data which has already been formed, explanations as to the structures and the data of the program structural table data are omitted.

Next, operations of the program planning supporting system in an instruction work will now be described in detail.

FIG. 5 is a flow chart for explaining sequential operations of the program planning supporting system in the instruction work. Also, FIG. 6 is a diagram for explaining process operations and data flows in the instruction work.

In the beginning, when the program planning person clicks the “new instruction input button” of the program structural table displayed on the screen of the structure work terminal, the instruction data input unit 11 initiates such an instruction data input screen as indicated in FIG. 7, the instruction data input unit 11 designates a program editing person, collects a necessary material, and inputs a detailed content of an edit work (step S101, process operation 1 of FIG. 6). When inputting of the instruction data is ended, the instruction data transmitting unit 12 registers the instruction data via the transmitting/receiving unit 40 to the storage apparatus 300 (step S102, process operation 2 and process operation 3 of FIG. 6). FIG. 8 is a schematic diagram for conceptionally indicating a data structure of the instruction data. In the instruction data, identifier information is contained. This identifier information specifies a program structural table and indicates an instructed place. The instruction data transmitting unit 12 transmits the identifier information of this instruction data to the response work terminal 200 (step S103, process operation 4 of FIG. 6).

The instruction data receiving unit 51 of the response work terminal 200 receives the identifier information via the transmitting/receiving unit 80 (step S104) so as to acquire the instruction data from the storage apparatus 300 based upon the identifier information (step S105, process operation 5 of FIG. 6). The instruction data receiving unit 51 transmits the acquired instruction data to the instruction data display unit 52, and then, the instruction data display unit 52 displays thereon the instruction data (step S106, process operation 6 of FIG. 6).

Next, operations of the program planning supporting system in a response work will now be described in detail.

FIG. 9 is a flow chart for explaining sequential operations of the program planning supporting system in the response work. Also, FIG. 10 is a diagram for explaining process operations and data flows in the response work.

In the beginning, when the program editing person clicks the “response input button” of the program structural table displayed on the screen of the structure work terminal, the response data input unit 61 initiates such a response data input screen as indicated in FIG. 11, the response data input unit 61 inputs such a response data that a material corresponding to the instruction data is collected and edited (step S201, process operation 7 of FIG. 10). When inputting of the response data is ended, the response data transmitting unit 62 registers the response data via the transmitting/receiving unit 80 to the storage apparatus 300 (step S202, process operation 8 and process operation 9 of FIG. 10). FIG. 12 is a schematic diagram for conceptionally indicating a data structure of the response data. In the response data, identifier information is contained. This identifier information specifies a program structural table and indicates an instructed place. The response data transmitting unit 12 transmits the identifier information of this instruction data to the structure work terminal 100 (step S203, process operation 10 of FIG. 10).

The response data receiving unit 21 of the structural work terminal 100 receives the identifier information via the transmitting/receiving unit 40 (step S204) so as to acquire the response data from the storage apparatus 300 based upon the identifier information (step S205, process operation 11 of FIG. 10). The response data receiving unit 21 transmits the acquired response data to the response data display unit 22, and then, the response data display unit 22 displays thereon the response data (step S206, process operation 10 of FIG. 12).

Next, operations of the program planning supporting system in a choose work will now be described in detail.

FIG. 13 is a flow chart for explaining sequential operations of the program planning supporting system in the choose work. Also, FIG. 14 is a diagram for explaining process operations and data flows in the choose work.

In the beginning, when the program planning person clicks the “choose input button” of the program structural table displayed on the screen of the structure work terminal, the chosen data input unit 31 initiates such a chosen data input screen as indicated in FIG. 15, and the program planning person inputs a chosen result and a content of this chosen result (step S301, process operation 13 of FIG. 14). When inputting of the chosen data is ended, the chosen data transmitting unit 32 registers the chosen data via the transmitting/receiving unit 40 to the storage apparatus 300 (step S302, process operation 14 and process operation 15 of FIG. 14). FIG. 16 is a schematic diagram for conceptionally indicating a data structure of the chosen data. In the chosen data, identifier information is contained. This identifier information specifies a program structural table and indicates an instructed place. The chosen data transmitting unit 32 transmits the identifier information of this chosen data to the response work terminal 200 (step S303, process operation 16 of FIG. 14).

The chosen data receiving unit 71 of the response work terminal 200 receives the identifier information via the transmitting/receiving unit 80 (step S304) so as to acquire the chosen data from the storage apparatus 300 based upon the identifier information (step S305, process operation 17 of FIG. 14). The chosen data receiving unit 71 transmits the acquired chosen data to the chosen data display unit 72, and then, the chosen data display unit 72 displays thereon the chosen data (step S306, process operation 18 of FIG. 14).

On the other hand, in the above-described embodiment 1, the below-mentioned setting operation is preferably employed in view of security. That is, when a user accesses the program structural table GUI screen corresponding to the initial screen, an ID authenticating operation, or the like is executed in order to set that only a program planning person and a program editing person, who are related to the relevant program (namely, program structural table), can access this program structural table GUI screen. Also, it is preferable that even when instruction data, response data, and chosen data are inputted, an authenticating operation is properly carried out in order to monitor as to whether or not inputting of these data is performed by such a person who owns a justified right.

As shown in FIG. 1, it should also be noted that the program planning supporting system of the above-explained embodiment 1 has been made as the system which is arranged by one set of the structure work terminal and one set of the response work terminal. However, a total number of the structure work terminal and the response work terminal need not be one, but may be alternatively selected to two, or more sets of these work terminals which may be used to arrange the above-described system.

As previously explained, in accordance with the program planning supporting system of the embodiment 1, the results of the instruction work, the response work, and the choose work are managed in a unified manner in relation to the program structural table. As a result, even in drama, a documentary program, and the like, namely in such programs that a material selecting operation and a picture editing operation are required to which a subjective intention of a program planning person is reflected, a complex instruction of the program planning person can be correctly grasped by the program edit person, and thus, response operations such as editing operations in correspondence with the instruction can be effectively carried out. Also, all of request and result contacts which have been made in an oral manner or in a written documentary form are stored in relation to the program structural table. As a result, for instance, a picture selecting history and a picture editing history can be correctly traced.

### EMBODIMENT 2

FIG. 17 is a diagram for representing an arrangement of a program planning supporting system according to an embodiment 2 of the present invention. The program planning supporting system shown in FIG. 17 is equipped with a structure work terminal 100, a response work terminal 200, and a storage apparatus 300, which is similar to the program planning supporting system of the embodiment 1. The structure work terminal 100 performs a structure work of a program structural table which is required for planning a program. The response work terminal 200 performs an edit work of the program structural table in response to an editing instruction which is required for the structure work of the program structural table. The storage apparatus 200 stores thereinto the program structural table, instruction data, response data, and chosen data. In addition, the program planning system of this embodiment 2 is equipped with a material historical data managing unit 310, which is different from that of the above-explained embodiment 1. The material historical data managing unit 310 produces material historical data and stores the produced material historical data in the storage apparatus 300. This material historical data causes a picture material selected in an edit work of a program structural table to be related to subjective information indicative of a feature of this picture material. As indicated in this drawing, the material historical data managing unit 310 is connected to a path which connects a transmitting/receiving unit 40 of the structure work terminal 100 to another transmitting/receiving unit 80 of the response work terminal 200, and also, is connected to the storage apparatus 300. As a consequence, the material historical data managing unit 310 may be alternatively arranged to be mounted within the same unit of the storage apparatus 300.

The material historical data managing unit 310 is equipped with a data sort judging unit 320, and a historical data succeeding unit 330. The data sort judging unit 320 monitors data which are transmitted and received by the structure work terminal 100 and the response work terminal 200 in order to judge sorts of these data (namely, instruction data, response data, and chosen data). The historical data succeeding unit 330 own the following functions, namely, a function which acquires subjective information indicative of a feature of a picture material related to each of the instruction data, the response data, and the chosen data from the instruction data, the response data, and the chosen data, which have been stored in the storage apparatus 300; a function for producing material historical data which causes the acquired subjective information to be related to the picture material; and a function which registers the produced material historical data into the storage apparatus 300. In the case that such a data judged as the chosen data by the data sort judging unit 320 is registered in the storage apparatus 300, the historical data succeeding unit 330 causes a picture material corresponding to this chosen data to be related to subjective information indicative of a feature of this picture material, and then, registers the related information as material historical data representative of a history of an edit work into the storage apparatus 300. It should also be noted that a detailed internal arrangement and operations of the historical data succeeding unit 330 will be explained later.

Next, a description is made of material historical data registering operations by the program planning supporting system with employment of the above-explained arrangement.

FIG. 18 is a diagram for explaining a summary as to works and process flow operations, which are executed by employing the program planning supporting system according to the embodiment 2 of the present invention.

As previously explained in the embodiment 1, in works which are performed by a program planning person and a program editing person (namely, instruction work performed from program planning person to program editing person, response work performed from program editing person to program planning person, and choose work performed from program planning person to program editing person), instruction data, response data, and chosen data are transmitted and received between the structure work terminal 100, and the response work terminal 200. While the data sort judging unit 320 of the material historical data managing unit 310 has judged a sort of data which is transmitted and received, when the data sort judging unit 320 senses that chosen data is registered to the storage apparatus 300, this data sort judging unit 320 sends out the chosen data to the historical data succeeding unit 330. The historical data succeeding unit 330 acquires the chosen data so as to specify a picture material which corresponds to the acquired chosen data, and furthermore, extracts subjective information representative of a feature of the picture material from the chosen data, and then, registers this extracted chosen data into the storage apparatus 300 as material historical data indicative of a history of an edit work.

FIG. 19 is a flow chart for describing sequential process operations executed in the program planning supporting system in a material historical data registering operation. FIG. 20 is a diagram for explaining process operations and data flows in the material historical data registering operation.

In the beginning, the data sort judging unit 320 of the material historical data managing unit 310 monitors that various sorts of data are transmitted and received between a structure work terminal of a program planning person and a response work terminal of a program editing person (step S401) in order to judge a data sort (step S402, process operation 1 of FIG. 20). Then, when the data sort judging unit 320 judges as to whether or not chosen data is registered (step S403) and the chosen data is registered, the historical data succeeding unit 330 acquires the chosen data, and perform a process operation for producing material historical data, which will be explained later (step S404, process operation 2 and process operation 3 of FIG. 20). On the other hand, when it is judged that the chosen data is not registered in the judging operation of the step S403, the process operation is returned to the step S402 for judging the data which is transmitted and received, and then, the above-explained sequential operation is repeatedly carried out. The produced material historical data is registered in the storage apparatus 300 (step S405, process operation 4 of FIG. 20).

In this connection, a historical data succeeding operation will now be explained in detail.

FIG. 21 is a diagram for indicating a detailed internal arrangement of the historical data succeeding unit 330. The historical data succeeding unit 330 is equipped with a succeeding process operation managing unit 331, an employed material succeeding unit 332, and an unemployed material succeeding unit 333. The succeeding process operation managing unit 331 judges as to whether such a chosen data which is acquired from the data sort judging unit 320 corresponds to chosen data indicative of an employment of a picture material, or chosen data indicative of an unemployment thereof. Also, the employed material succeeding unit 332 produces material historical data by causing a picture material designated by chosen data indicative of an employment to the related to subjective information related to a feature of this picture material. Also, the unemployed material succeeding unit 333 produces material historical data by causing a picture material designated by chosen data indicative of an unemployment to be related to subjective information related to a feature of this picture material. Onto the material historical data, the subjective information indicative of the feature of this picture material, for instance, an edit instruction to the program planning person and the edit instruction being employed, or not employed is reflected. Also, the material historical data produced in both the employed material succeeding unit 332 and the unemployed material succeeding unit 333 are registered to the storage apparatus 300.

FIG. 22 is a flow chart for indicating sequential process operations of the program planning supporting system in the historical data succeeding operation. Referring to FIG. 21, process operations and data flows in the historical data succeeding operation are explained.

In the beginning, the succeeding process operation managing unit 331 of the historical data succeeding unit 330 acquires the chosen data from the data sort judging unit 320 (step S501, process operation 2 of FIG. 21), and analyzes the acquired data to grasp a decision as to whether the chosen data is employed or not employed (step S502). Concretely speaking, the succeeding process operation managing unit 333 refers to chosen result information of the chosen data (refer to FIG. 16). In the case that the chosen result information is “OK”, namely the chosen data indicative of the employment in the judging operation of the chosen data (step S503), the process operation is advanced to the employed material succeeding unit 332, so that material historical data is produced (step S504, process operation 3-1 of FIG. 21). On the other hand, in the case that the chosen result information is “NG”, namely the chosen data indicative of the unemployment, the process operation is advanced to the unemployed material succeeding unit 333, so that material historical data is produced (step S505, process operation 3-2 of FIG. 21).

In this connection, a description is made of the material historical data producing operations executed in both the employed material succeeding unit 332 and the unemployed material succeeding unit 333. First of all, FIG. 23 is a flow chart for describing sequential processing operations for producing material historical data in the employed material succeeding unit 332. The employed material succeeding unit 332 acquires chosen data indicative of an employment from the succeeding process operation managing unit 331 (step S601) and acquires respective values as to program ID, instruction ID, and an instruction number (step S602). The employed material succeeding unit 332 retrieves response data of the same instruction time as the acquired instruction time from the storage apparatus 300 so as to acquire this response data (step S603), and then, extracts material ID from the acquired response data (step S604).

Next, the employed material succeeding unit 332 judges as to whether or not such a material historical data having the same ID as the material ID of the acquired chosen data has been registered in the past (step S605). When the above-explained material historical data has been registered, the employed material succeeding unit 332 firstly acquires the relevant material historical data from the storage apparatus 300 (step S606). Next, the employed material succeeding unit 332 retrieves all of the instruction data while program ID and instruction ID of chosen data are used as a key, and acquires the retrieved instruction data (step S607). Further, the employed material succeeding unit 332 acquires instruction content data from the acquired instruction data (step S608), and reflects the acquired instruction content to such a material historical data which has already been registered (step S609). On the other hand, when the above-explained material historical data has not yet been registered, the employed material succeeding unit 332 retrieves all of the instruction data while the program ID and the instruction ID of the employed data are used as a key, and acquires the retrieved instruction data (step S610). In addition, the employed material succeeding unit 332 acquires instruction content data from the acquired instruction data (step S611), and then, produces such a material historical data that the material ID is related to the acquired instruction data (step S612).

Next, FIG. 24 is a flow chart for describing sequential processing operations for producing material historical data in the unemployed material succeeding unit 333. The unemployed material succeeding unit 333 acquires chosen data indicative of an unemployment from the succeeding process operation managing unit 331 (step S701) and acquires respective values as to program ID, instruction ID, an instruction number, and a reason of an unemployment (step S702). The unemployed material succeeding unit 333 retrieves response data of the same instruction time as the acquired instruction time from the storage apparatus 300 so as to acquire this response data (step S703), and then, extracts material ID from the acquired response data (step S704).

Next, the unemployed material succeeding unit 333 judges as to whether or not such a material historical data having the same ID as the material ID of the acquired chosen data has been registered in the past (step S705). When the above-explained material historical data has been registered, the unemployed material succeeding unit 333 firstly acquires the relevant material historical data from the storage apparatus 300 (step S706). Next, the unemployed material succeeding unit 333 retrieves all of the instruction data while program ID and instruction ID of chosen data are used as a key, and acquires the retrieved instruction data (step S707). Further, the unemployed material succeeding unit 333 acquires instruction content data from the acquired instruction data (step S708), and reflects the acquired instruction content and the reason of unemployment to such a material historical data which has already been registered (step S709). On the other hand, when the above-explained material historical data has not yet been registered, the unemployed material succeeding unit 333 retrieves all of the instruction data while the program ID and the instruction ID of the chosen data are used as a key, and acquires the retrieved instruction data (step S710). In addition, the unemployed material succeeding unit 333 acquires instruction content from the acquired instruction data (step S711), and then, produces such a material historical data that the material ID and the acquired instruction data are related to the reason of the unemployment (step S712).

FIG. 25 is a schematic diagram for conceptionally showing data structures of material historical data to be produced. Both material ID and an instruction content are held in the material historical data which is produced from chosen data indicative of an employment, whereas material ID, an instruction content, and a reason of an unemployment are held in the material historical data which is produced from chosen data indicative of an unemployment.

The material historical data is registered in accordance with the above-explained sequential operations. The subjective information (for example, in example shown in drawings, edit instruction of program planning person, “dark”, and “cloudy”) made by the program planning person is also covered by the material historical data in addition to the objective information (for example, in example shown in drawings, “KANAZAWA SAMURAI HOUSE”) related to this picture material. As a consequence, while the objective information and the subjective information are employed as the keywords, a desirable material can be properly and quickly retrieved.

The below-mentioned description concretely explains such a material historical data which is produced while the program planning person and the program editing person issue instructions and responses. FIG. 26 is a schematic diagram for explaining flows of data to be produced, and instructions, responses, and choices, which are transmitted and received between the program planning person and the program editing person.

In the beginning, when the program planning person instructs a necessary picture material and a concrete image with respect to this necessary picture material within the program structural table, as shown in FIG. 27, an instruction content is transmitted as instruction data to the program editing person (process operation A). On the other hand, the program editing person performs a picture retrieving process operation and a picture editing operation based upon the instruction, and when the program editing person inputs a processed result as a picture material corresponding to an instruction contact within the program structural table, as indicated in FIG. 28, the input content is transmitted as response data to the program planning person (process operation B).

The program planning person considers the content of the result report issued from the program editing person, and determines as to whether or not the relevant picture material is employed. In the example shown in FIG. 26, the considered picture material is not employed because of such a picture material which is not fitted to the image of the program planning person. As a result, as shown in FIG. 29, the chosen data indicative of the unemployment is transmitted to the program editing person (process operation C).

When the data sort judging unit 320 senses the registering operation of the chosen data, the chosen data is sent to the historical data succeeding unit 330. In this case, such a material historical data as shown in FIG. 30 is produced in the unemployed material succeeding unit 333. The subjective description (reason of unemployment) of the program planning person is held in this material historical data, while the subjective description indicates the feature of the picture material such as “dark, cloudy.”

Next, when the program planning person additionally instructs a more detailed image with respect to the necessary picture material, as indicated in FIG. 31, an instruction content is transmitted to the program editing person (process operation D). As to the instruction data in the additional instruction, program ID, a sequence number, a scene number, a cut number, and instruction ID are identical to those of the instruction data. However, a value of an instruction time has been incremented to 2. On the other hand, the program editing person again performs a picture retrieving operation and a picture editing operation based upon the additional instruction, and when the program editing person inputs the result as a picture material corresponding to the instruction contact within the program structural table, as shown in FIG. 32, the input content is transmitted as response data to the program planning person (process operation E). In this case, since the picture material different from the picture material of the first time is retrieved and edited, the material ID of the response data has a different value from that of the first time.

The program planning person considers the content of the result report issued from the program editing person, and determines as to whether or not the relevant picture material is employed. In the example shown in FIG. 26, the considered picture material is employed because of such a picture material which is fitted to the image of the program planning person. As a result, as shown in FIG. 33, the chosen data indicative of the employment is transmitted to the program editing person (process operation F).

When the data sort judging unit 320 senses the registering operation of the chosen data, the chosen data is sent to the historical data succeeding unit 330. In this case, such a material historical data as shown in FIG. 34 is produced in the employed material succeeding unit 332.

As previously explained, in accordance with the program planning supporting system of the embodiment 2, such a material historical data is produced in which the picture material is related to the subjective information indicative of the feature of this picture material, and then, the produced material historical data is stored in the storage apparatus 300. As a result, since the picture material can be retrieved based upon the subjective information, the desirable picture material can be properly and quickly retrieved.

### EMBODIMENT 3

Next, a description is made of a program planning supporting system operated in such a manner that in the historical data succeeding operation of the historical data succeeding unit 330, an antonym keyword is formed from instruction data based upon unemployed chosen data so as to produce material historical data.

FIG. 35 is a diagram for representing a detailed internal arrangement of a historical data succeeding unit of a program planning supporting system according to an embodiment 3 of the present invention. The above-described historical data succeeding unit owns a different point from the historical data succeeding unit 330 of the embodiment 2, namely, a keyword antonym converting unit 400 connected to an unemployed material succeeding unit 333 is provided in the historical data succeeding unit 330. The unemployed material succeeding unit 333 produces material historical data by causing a picture material which is designated by chosen data indicative of an unemployment to be related to subjective information as to a feature of this picture material. As will be explained later, an antonym having an instruction content which is contained in instruction data is produced by the keyword antonym converting unit 400, and this produced antonym is employed in the material historical data as subjective information. The subjective information properly indicates a feature of a picture material which constitutes a subject.

It should also be understood that since other system arrangements of the program planning supporting system according to this embodiment 3 are the same as those of the embodiment 2 (refer to FIG. 17), explanations thereof are omitted.

FIG. 36 to FIG. 39 are diagrams for explaining process operations and data flows in the historical data succeeding unit 330 which contains the keyword antonym converting unit 400. Such a case is supposed that as to a material of Mt. Fuji, a communication is established between a program planning person and a program editing person.

In the beginning, the unemployed material succeeding unit 333 acquires chosen data which is not employed, and both response data and instruction data, which correspond to the chosen data, are acquired from the storage apparatus 300 (FIG. 36, process operation 1). Then, the unemployed material succeeding unit 333 acquires all of the instruction contents of the instruction data, and then outputs all of the acquired instruction contents to the keyword antonym converting unit 400 (FIG. 37, process operation 2). As shown in the drawing, in such a case that an acquisition of a material such as “large Mt. Fuji” is instructed, when such an instruction content as “large” (namely, instruction word) is outputted to the keyword antonym converting unit 400, this keyword antonym converting unit 400 produces such an antonym “small” of the instruction work by executing a keyword antonym converting process operation (will be explained later). The unemployed material succeeding unit 333 acquires the produced antonym (FIG. 38, process operation 3), and produces material historical data as the subjective information indicative of the feature of the picture material related to the unemployed chosen data (FIG. 39, process operation 4). A table shown in FIG. 39 conceptionally indicates a data structure of the material historical data.

Next, a description is made of material historical data producing operations executed by the unemployed material succeeding unit 333 of the program planning supporting system having the above-described arrangement. It should be understood that since sequential operations for producing the material historical data executed in the employed material succeeding unit 332 are identical to those of the above-explained embodiment 1, explanations thereof are omitted. FIG. 40 is a flow chart for explaining sequential process operations for producing material historical data performed in the unemployed material succeeding unit 333.

The unemployed material succeeding unit 333 acquires chosen data indicative of an unemployment from the succeeding process operation managing unit 331 (step S801) and acquires respective values as to program ID, instruction ID, an instruction number, and a reason of an unemployment (step S802, process operation 1-a of FIG. 36). The unemployed material succeeding unit 333 retrieves response data of the same instruction time as the acquired instruction time from the storage apparatus 300 and acquires this response data (step S803), and then, extracts material ID from the acquired response data (step S804, process operation 1-b of FIG. 36).

Next, the unemployed material succeeding unit 333 judges as to whether or not such a material historical data having the same ID as the material ID of the acquired chosen data has been registered in the past (step S805). When the above-explained material historical data has been registered, the unemployed material succeeding unit 333 firstly acquires the relevant material historical data from the storage apparatus 300 (step S806). Next, the unemployed material succeeding unit 333 retrieves all of the instruction data while program IDs and instruction IDs of chosen data are used as a key, and acquires the retrieved instruction data (step S807). Further, the unemployed material succeeding unit 333 acquires instruction content data from the acquired instruction data (step S808). The unemployed material succeeding unit 333 inputs all of the instruction contents to the keyword antonym converting unit 400 (step S809). The keyword antonym converting unit 400 performs the keyword antonym converting process operation as to the instruction word based upon the inputted instruction content, while the keyword antonym converting process operation produces an antonym instruction word in a sequential operation (will be explained later) (step S810).

Next, the unemployed material succeeding unit 333 acquires the antonym instruction word which is produced by the keyword antonym converting unit 400 (step S811), and reflects the acquired antonym instruction word and a word of an unemployed reason (will be referred to as “unemployed word” hereinafter) onto the previously registered material historical data (step S812).

On the other hand, when the above-explained material historical data has not yet been registered, the unemployed material succeeding unit 333 retrieves all of the instruction data while the program ID and the instruction ID of the employed data are used as a key, and acquires the retrieved instruction data (step S813, process operation 1-c of FIG. 36). In addition, the unemployed material succeeding unit 333 acquires instruction content from the acquired instruction data (step S814), and then, inputs all of the instruction contents to the keyword antonym converting unit 400 (step S815, process operation 2 of FIG. 37). The keyword antonym converting unit 400 performs the keyword antonym converting process operation as to the instruction word based upon the inputted instruction content, while the keyword antonym converting process operation produces an antonym instruction word in a sequential operation (will be explained later) (step S816).

Next, the unemployed material succeeding unit 333 acquires the antonym instruction word produced by the keyword antonym converting unit 400 (step S817, process operation 3 of FIG. 38), and produces material historical data from the material ID, the antonym instruction word, and the unemployed word (step S818, process operation 4 of FIG. 39).

FIG. 41 is a diagram for schematically showing concrete data flows in the unemployed material succeeding unit 333. In this embodiment 3, the antonym instruction word converted by the keyword antonym converting unit 400, and the unemployed word based upon the unemployment reason correspond to data which are employed as the material content of the material historical data.

In this connection, a detailed description is made of the keyword antonym converting process operation executed by the keyword antonym converting unit 400. FIG. 42 is a flow chart for explaining sequential process operations for converting the keyword antonym performed by the keyword antonym converting unit 400.

In the beginning, the keyword antonym converting unit 400 which has acquired the instruction content from the unemployed material succeeding unit 333 (step S901) decomposes the instruction content into words (step S902). For instance, such an instruction as “large picture” issued from the program planning person to the program editing person is decomposed into “large” and “picture”, and then, the word of “large” which is judged as the instruction content is extracted as the instruction word. It should also be understood that as a method of decomposing a sentence into words in the minimum unit, the known decomposing method may be employed.

Next, the keyword antonym converting unit 400 converts the instruction word into an antonym thereof (step S903). As this converting method, such a known method that a dictionary which has registered paired words is utilized may be employed. In the example shown in the drawing, since an antonym as to the instruction word of “large” is required, this instruction word is converted into a word of “small.” Then, the keyword antonym converting unit 400 outputs the converted instruction word to the unemployed material succeeding unit 333 (step S904). Such a fact that the picture provided by the program editing person with respect to such an instruction of “large picture of Mt. Fuji” is not employed may be conceived as follow: That is, the program planning person judges that this picture is “not large”, namely “small” in view of the subjective idea. As a consequence, the word of “small” which is the antonym of “large” can be employed as the material historical data of this picture.

The material historical data is registered in accordance with the above-explained sequential operation. Since the subjective information (for example, in example shown in drawing, description indicative of feature of picture such as “large/small” related to picture of Mt. Fuji) made by the program planning person is converted by the material historical data, a desirable picture material can be quickly and properly retrieved in a subsequent step while these data are used as a keyword. The above-described example has exemplified such a case that the instruction content is a single content. However, the present invention may be apparently applied to another case that the instruction contents are plural contents.

The below-mentioned description concretely explains such a material historical data which is produced while the program planning person and the program editing person issue instructions and responses. FIG. 43 is a schematic diagram for explaining flows of data to be produced, and instructions, responses, and choices, which are transmitted and received between the program planning person and the program editing person.

In the beginning, when the program planning person instructs a necessary picture material and a concrete image with respect to this necessary picture material within the program structural table, as shown in FIG. 44, an instruction content is transmitted as instruction data to the program editing person (process operation A). On the other hand, the program editing person performs a picture retrieving process operation and a picture editing operation based upon the instruction, and when the program editing person inputs a processed result as a picture material corresponding to an instruction contact within the program structural table, as indicated in FIG. 45, the input content is transmitted as response data to the program planning person (process operation B).

The program planning person considers the content of the result report issued from the program editing person, and determines as to whether or not the relevant picture material is employed. In the example shown in FIG. 43, the considered picture material is not employed because of such a picture material which is not fitted to the image of the program planning person. As a result, as shown in FIG. 46, the chosen data indicative of the unemployment is transmitted to the program editing person (process operation C). Since this example corresponds to the example as to the unemployed material succeeding unit 333, descriptions as to transmitting and receiving of instructions and responses in the employment case are omitted.

As previously explained, in accordance with the program planning supporting system of the embodiment 3, since the material historical data is produced by employing the antonym of the instruction word, the subjective information capable of properly indicating the feature of the unemployed picture material can be related to this picture. As a consequence, the picture material can be retrieved based upon the subjective information, so that the desirable picture material can be properly and quickly retrieved.

### EMBODIMENT 4

Next, a description is made of a program planning supporting system operated in such a manner that in the historical data succeeding operation of the historical data succeeding unit 330, an improper keyword different from a material content is deleted from instruction data so as to produce material historical data.

FIG. 47 is a diagram for representing a detailed internal arrangement of a historical data succeeding unit of a program planning supporting system according to an embodiment 4 of the present invention. The above-described historical data succeeding unit owns a different point from the historical data succeeding unit 330 of the embodiment 2, namely, an improper keyword deleting unit 410 connected to an unemployed material succeeding unit 333 is provided in the historical data succeeding unit 330. The unemployed material succeeding unit 333 produces material historical data by causing a picture material which is designated by chosen data indicative of an unemployment to be related to subjective information as to a feature of this picture material. As will be explained later, an improper keyword is deleted from an instruction content contained in instruction data is deleted by the improper keyword deleting unit 410, and only a proper instruction content is employed in the material historical data as subjective information which indicates a feature of a picture material to become a subject.

It should also be understood that since other system arrangements of the program planning supporting system according to this embodiment 4 are the same as those of the embodiment 2 (refer to FIG. 17), explanations thereof are omitted.

FIG. 48 to FIG. 51 are diagrams for explaining process operations and data flows in the unemployed material succeeding unit 333 which contains the improper keyword deleting unit 410.

In the beginning, the unemployed material succeeding unit 333 acquires chosen data which is not employed, and both response data and instruction data, which correspond to the chosen data, are acquired from the storage apparatus 300 (FIG. 48, process operation 1). Then, the unemployed material succeeding unit 333 acquires all of the instruction contents of the instruction data, and employment reasons (unemployment reasons) of chosen data, and then, outputs the acquired instruction contents and the acquired employment reasons to the improper keyword deleting unit 410 (FIG. 49, process operation 2). In an example shown in the drawing, such a case is supposed that a communication is established between a program planning person and a program editing person as to a material of Mt. Fuji. When such an instruction content (instruction word) as “large and light”, and a word of “small” corresponding to an unemployment reason are outputted to the improper keyword deleting unit 410, the improper keyword deleting unit 410 deletes the instruction word of “large” from the instruction word by executing an improper keyword deleting process operation (will be explained). On the other hand, the instruction word of “light” is not deleted. The unemployed material succeeding unit 333 acquires the instruction word obtained after the deleting process operation has been carried out, and the unemployment reason (FIG. 50, process operation 3), and produces material historical data as the subjective information indicative of the feature of the picture material related to the unemployed chosen data (FIG. 51, process operation 4). A table shown in FIG. 51 conceptionally indicates a data structure of the material historical data. As the material content, the words of “light” and “small” have been employed.

Next, a description is made of material historical data producing operations executed by the unemployed material succeeding unit 333 of the program planning supporting system having the above-described arrangement. It should be understood that since sequential operations for producing the material historical data executed in the employed material succeeding unit 332 are identical to those of the above-explained embodiment 1, explanations thereof are omitted. FIG. 52 is a flow chart for explaining sequential process operations for producing material historical data performed in the unemployed material succeeding unit 333.

The unemployed material succeeding unit 333 acquires chosen data indicative of an unemployment from the succeeding process operation managing unit 331 (step S1001) and acquires respective values as to program ID, instruction ID, an instruction number, and a reason of an unemployment (step S1002, process operation 1-a of FIG. 48). The unemployed material succeeding unit 333 retrieves response data of the same instruction time as the acquired instruction time from the storage apparatus 300 so as to acquire this response data (step S1003), and then, extracts material ID from the acquired response data (step S1004, process operation 1-b of FIG. 48).

Next, the unemployed material succeeding unit 333 judges as to whether or not such a material historical data having the same ID as the material ID of the acquired chosen data has been registered in the past (step S1005). When the above-explained material historical data has been registered, the unemployed material succeeding unit 333 firstly acquires the relevant material historical data from the storage apparatus 300 (step S1006). Next, the unemployed material succeeding unit 333 retrieves all of the instruction data while program ID and instruction ID of chosen data are used as a key, and acquires the retrieved instruction data (step S1007). Further, the unemployed material succeeding unit 333 acquires instruction content data from the acquired instruction data (step S1008), and inputs all of the instruction contents and all of the unemployment reasons of the chosen data to the improper keyword deleting unit 410 (step S1009). The improper keyword deleting unit 410 executes an improper keyword deleting process operation in accordance with a sequential operation (will be explained later) as to the instruction word and the unemployed word based upon the inputted instruction contents and the inputted unemployment reason (step S1010).

Next, the unemployed material succeeding unit 333 acquires the instruction word and the unemployed word, which are delete-processed by the improper keyword deleting unit 410 (step S1011), and reflects the acquired instruction word and the acquired unemployed word onto the previously registered material historical data (step S1012).

On the other hand, when the above-explained material historical data has not yet been registered, the unemployed material succeeding unit 333 retrieves all of the instruction data while the program ID and the instruction ID of the chosen data are used as a key, and acquired the retrieved instruction data (step S1013, process operation 1-c of FIG. 48). In addition, the unemployed material succeeding unit 333 acquires instruction content from the acquired instruction data (step S1014), and then, inputs all of the acquired instruction contents and the unemployment reasons of the chosen data into the improper keyword deleting unit 410 (step S1015, process operation 2 of FIG. 49). The improper keyword deleting unit 410 executes an improper keyword deleting process operation in accordance with a sequential operation (will be explained later) as to the instruction word and the unemployed word based upon the inputted instruction content and the unemployed reason (step S1016).

Next, the unemployed material succeeding unit 333 acquires the instruction word and the unemployed word which have been delete-processed in the improper keyword deleting unit 410 (step S1017, process operation 3 of FIG. 50), and produces material historical data from the material ID, the antonym instruction word, and the unemployed word (step S1018, process operation 4 of FIG. 51).

FIG. 53 is a diagram for schematically showing concrete data flows in the unemployed material succeeding unit 333. In this embodiment 4, the remaining instruction word deleted by the improper keyword deleting unit 410, and the unemployed word based upon the unemployed reason correspond to data which are employed as the material content of the material historical data.

In this connection, a detailed description is made of the improper keyword deleting process operation executed by the improper keyword deleting unit 410. FIG. 54 is a flow chart for explaining sequential process operations for deleting the improper keyword by the improper keyword deleting unit 410.

In the beginning, the improper keyword deleting unit 410 which has acquired both the instruction content and the unemployed reason from the unemployed material succeeding unit 33 (step S1101) firstly decomposes the instruction content (step S1102), and subsequently decomposes the unemployment reason into words (step S1102, step S1103). For instance, such an instruction “large and light” issued from the program planning person to the program editing person is decomposed into “large” and “light”, and then, the words of “large” and “light” which are judged as the instruction content is extracted as the instruction words. It should also be understood that as a method of decomposing a sentence into words in the minimum unit, the known decomposing method may be employed.

Next, the improper keyword deleting unit 410 judges as to whether or not either an antonym or a negative word of the unemployed word is contained in the instruction word (step S1104). As this judging method such a known method that a dictionary which has registered paired words is used may be employed. In the case that either the antonym or the negative word is contained, the improper keyword deleting unit 410 deletes this instruction word (step S1105). In the example shown in the drawing, the word of “large” which corresponds to the negative word of the unemployment reason of “small” is contained in the instruction word, so that this word of “large” is deleted as the improper keyword. Then, the improper keyword deleting unit 410 outputs such an instruction word which is left after the deleting process operation has been performed, and also the unemployed word to the unemployed material succeeding unit 333 (step S1106). Such a fact that a picture provided by the program editing person is unemployed with respect to such an instruction of “a large and light image of Mt. Fuji” implies that the subjective information of the program planning person with respect to this provided picture is equal to “small”, namely the unemployment reason. As a consequence, the instruction word of “large” which corresponds to the antonym as to the word of “small” is improper, and thus, must be deleted from the material historical data. On the other hand, since there is no unemployment reason other than the above-explained case, the improper keyword judging unit 410 judges that this picture is made coincident with the instruction of “light” issued from the program planning person. As a consequence, the instruction word of “light” maybe employed as the material historical data. Similarly, the word of “small” corresponding to the unemployment reason is also employed in the material historical data as the effective subjective information of this picture.

The material historical data is registered in accordance with the above-explained sequential operation. Since the subjective information (for example, in example shown in drawing, description indicative of feature of picture such as “large/small” related to picture of Mt. Fuji) made by the program planning person is covered by the material historical data, a desirable picture material can be quickly and properly retrieved in a subsequent step while these data are used as a keyword. In accordance with this embodiment 4, in such a case that since an instruction content contains a plurality of instruction words and cannot satisfy such a condition indicated by a portion of the instruction words, this instruction content is not employed, and also, even in the case that an antonym cannot be specified, for instance, a plurality of candidates are present in the antonym of the instruction word, and an antonym is not present, the proper keyword which is made coincident with the subjective intention of the program planning person can be employed as the material historical data.

The below-mentioned description concretely explains such a material historical data which is produced while the program planning person and the program editing person issue instructions and responses. FIG. 55 is a schematic diagram for explaining flows of data to be produced, and instructions, responses, and choices, which are transmitted and received between the program planning person and the program editing person.

In the beginning, when the program planning person instructs a necessary picture material and a concrete image with respect to this necessary picture material within the program structural table, as shown in FIG. 56, an instruction content is transmitted as instruction data to the program editing person (process operation A). On the other hand, the program editing person performs a picture retrieving process operation and a picture editing operation based upon the instruction, and when the program editing person inputs a processed result as a picture material corresponding to an instruction contact within the program structural table, as indicated in FIG. 57, the input content is transmitted as response data to the program planning person (process operation B).

The program planning person considers the content of the result report issued from the program editing person, and determines as to whether or not the relevant picture material is employed. In the example shown in FIG. 55, the considered picture material is not employed because of such a picture material which is not fitted to the image of the program planning person. As a result, as shown in FIG. 58, the chosen data indicative of the unemployment is transmitted to the program editing person (process operation C). Since this example corresponds to the example as to the unemployed material succeeding unit 333, descriptions as to transmitting and receiving of instructions and responses in the employment case are omitted.

As previously explained, in accordance with the program planning supporting system of the embodiment 4, since the material historical data is produced by deleting the improper instruction word which corresponds to the antonym of the unemployment reason, only the subjective information capable of properly indicating the feature of the unemployed picture material can be related to this picture. As a consequence, the picture material can be retrieved based upon the subjective information, so that the desirable picture material can be properly and quickly retrieved.

In particular, the above-explained program planning supporting system is useful in such a program planning operation that the editing work and the like are mainly carried out based upon the subjective planning instruction of the program planning person, for instance, drama and documentary programs.

While the present invention has been described in detail, or with reference to the specific embodiments, it is obvious for the ordinarily skilled engineers to modify, or change the present invention in various ways without departing from the technical scope and spirit of the present invention.

The present patent application has been made based upon Japanese patent application (Application No. 2004-279777) filed on Sep. 27, 2004 and Japanese patent application (Application No. 2005-264109) filed on Sep. 1, 2005, the contents of which are incorporated herein as references.

### INDUSTRIAL APPLICABILITY

The present invention owns such an effect that every time either the instruction data or the response data is transmitted from either the structure work terminal or the response work terminal, since either the instruction data or the response data is reflected onto the program structural table, the program can be planned based upon the program structural table onto which the intention of the program planning person is properly reflected, and thus, the work efficiency of the program planning operation can be improved. The present invention maybe useful in a program planning supporting system, and the like which are used in a broadcasting station and the like.

1. A program planning supporting system comprising:
a structure work terminal for performing a structure work of a program structural table which is required to plan a program; and
a response work terminal for performing an edit work of the program structural table in response to an editing instruction required in the structure work of the program structural table,
wherein the structure work terminal comprises:
an instruction data inputting unit for inputting editing instruction data required for the editing instruction;
an instruction data transmitting unit for transmitting the editing instruction data to the response work terminal;
a response data receiving unit for receiving response data transmitted by the response work terminal; and
a response data display unit for displaying the received response data in relation to the program structural table; and
wherein the response work terminal comprises:
an instruction data receiving unit for receiving the editing instruction data transmitted by the structure work terminal;
an instruction data display unit for displaying the received editing instruction data in relation to the program structural table;
a response data inputting unit for inputting response data which is required in the edit work; and
a response data transmitting unit for transmitting the response data to the structure work terminal.

2. The program planning supporting system according to claim 1,
wherein the structure work terminal comprises:
a chosen data inputting unit for inputting chosen data which is required to choose the edit work performed by the response work terminal; and
a chosen data transmitting unit for transmitting the inputted chosen data to the response work terminal; and
wherein the response work terminal comprises:
a chosen data receiving unit for receiving chosen data which is transmitted by the structure work terminal; and
a chosen data display unit for displaying the received chosen data in relation to the program structural table.

3. The program planning supporting system according to claim 2, further comprising:
a storage apparatus for storing thereinto the editing instruction data, the response data, and the chosen data; and
a material historical data managing unit including:
a subjective information acquiring unit which acquires for acquiring subjective information indicative of features of picture materials which are related to the editing instruction data, the response data, and the chosen data from the instruction data, the response data, and the chosen data stored in the storage apparatus, respectively;
a material historical data producing unit which produces material historical data which causes the acquired subjective information to be related to the picture material; and
a material historical data registering unit which registers the produced material historical data into the storage apparatus.

4. The program planning supporting system according to claim 3,
wherein the material historical data managing unit includes a data judging unit for judging that the chosen data is stored in the storage apparatus, and
wherein the material historical data producing unit produces the material historical data at a time when the chosen data is stored in the storage apparatus.

5. The program planning supporting system according to claim 3, wherein the material historical data producing unit includes a keyword antonym converting unit for producing an antonym of a word which is contained in the instruction content of the instruction data, and relates the antonym to be as the subjective information of an unemployed picture material.

6. The program planning supporting system according to claim 3, wherein the material historical data producing unit includes an improper keyword deleting unit for deleting a word which corresponds to an antonym of a word contained in an unemployment reason of the chosen data from words contained in an instruction content of the instruction data, and relates both the word contained in the instruction content after deletion and the word contained in the unemployed reason to be as the subjective information of the unemployed picture material.

7. A program structural table required for planning a program, comprising:
an editing instruction region for displaying a content of an editing instruction which is required in a structure work of the program structural table in accordance with a program progress; and
an editing work region for displaying a content of an edit work which is executed with respect to the editing instruction in correspondence with the editing instruction.
